(19) United States
(12) Patent Application Publication
(10) Pub. No.: US 2011/0184654 A1
(43) Pub. Date: Jul. 28, 2011

(54) Means and Methods for Detecting Bacteria in an Aerosol Sample

(75) Inventors: Moshe Ben-David, Tel Aviv (IL); Gallya Gannot, Ramat HaSharon (IL); Tomer Eruv, Kfar Tapuah (IL); Zvi Markowitz, Jerusalem (IL)

(73) Assignee: OPTICUL DIAGNOSTICS LTD., Tel Aviv (IL)

(21) Appl. No.: 13/062,790

(22) PCT Filed: Sep. 16, 2009
(86) PCT No.: PCT/IL2009/000908

§ 371 Date: Mar. 8, 2011

Related U.S. Application Data
(60) Provisional application No. 61/097,568, filed on Sep. 17, 2008.

(51) Int. Cl. G06F 19/00

(52) U.S. Cl. 702/19

(57) ABSTRACT

This disclosure provides a method for detecting and/or identifying uncultured bacteria. The sample is an aerosol sample selected from a group consisting of cough, sneeze, saliva, mucus, bile, urine, vaginal secretions, middle ear aspirate, pus, pleural effusions, synovial fluid, abscesses, cavity swabs, serum, blood and spinal fluid. The method comprises obtaining absorption spectra (AS) of the sample, extracting and processing the acquired data, thereby detecting and/or identifying the bacteria.

### FIELD OF THE INVENTION

The present invention relates to the field of spectroscopic medical diagnostics of specific bacteria within a sample. More particularly, the present invention provides means and methods for detecting different kinds of bacteria in an aerosol sample by using spectroscopic measurements. The detection can be used for both medical and non-medical applications, such as detecting bacteria in water, beverages, food production lines, sensing for hazardous materials in crowded places, bio-defense etc.

### BACKGROUND OF THE INVENTION

The identification of microorganisms is clearly of great importance in the medical fields. Furthermore, in recent years the need for efficient and relatively rapid identification techniques has become even more pressing owing to the remarkable expansion of environmental and industrial microbiology. One field in which it there is an urgent need for a rapid and accurate identification of bacteria in an aerosol environment.

Respiratory disease is an umbrella term for diseases of the lung, bronchial tubes, trachea and throat. These diseases range from mild and self-limited (coryza- or common cold) to being life-threatening, (bacterial pneumonia, or pulmonary embolism for example).

Respiratory diseases can be classified as either obstructive or restrictive. Obstructive is a condition which impede the rate of flow into and out of the lungs (e.g., asthma); and restrictive is a condition which cause a reduction in the functional volume of the lungs (e.g., pulmonary fibrosis).

Respiratory disease can be further subdivided as either upper or lower respiratory tract (most commonly used in the context of infectious respiratory disease), parenchymal and vascular lung diseases.

Infectious Respiratory Diseases are, as the name suggests, typically caused by one of many infectious agents able to infect the mammalian respiratory system, the etiology can be viral or bacterial (for example the bacterium Streptococcus pneumoniae).

A patient who suffers from infectious respiratory diseases will usually endure sore throat and have trouble swallowing. However, these symptoms might indicate also a flu.

Usually a throat culture is taken from the patient, that is suspected to have strep throat, in order to correctly diagnose the infection and to give the proper treatment.

The throat culture and bacterial analysis will usually take about three days. Moreover, the test causes some inconvenience to the patient.

The bacterial analysis will determine what is the desired and correct treatment and medication.

Another kind of tests are the “rapid” Strep. A tests. In these tests, a throat swab is inserted into a reagent and the presence of the bacteria is determined according to the chemical reaction between the bacteria and the reagent. Although these test give fast results (10 to 30 minutes) their sensitivity is very poor and they are not user friendly. Therfore they are not commonly used by the medical stuff.

Usually the physician desires to know if the bacteria is present and then prescribe antibiotics. Therefore, it will be beneficial for the doctor and the patient alike to get an immediate response for the throat sample.

An immediate response might be obtained by sampling the exhaled debrit (exhaled gases and micro fluids) of coughing or other human fluids (saliva, mucos etc.) and optically characterizing their content. Optically characterizing the sample will likely be more convenient for the patient than the usual throat culturing.

Some spectroscopic techniques already known in the art. For example, PCT No. WO 98/41842 to NELSON, Wilfred discloses a system for the detection of bacteria antibody complexes. The sample to be tested for the presence of bacteria is placed in a medium which contains antibodies attached to a surface for binding to specific bacteria to form an antigen—antibody complex. The medium is contacted with an incident beam of light energy. Some of the energy is emitted from the medium as a lower resonance enhanced Raman backscattered energy. The detection of the presence or absence of the microorganism is based on the characteristic spectral peak of said microorganism. In other words PCT No. WO 98/41842 uses UV resonance Raman spectroscopy.

U.S. Pat. No. 6,599,715 to Laura A. Vanderberg relates to a process for detecting the presence of viable bacterial spores in a sample and to a spore detection system. The process includes placing a sample in a germination medium for a period of time sufficient for commitment of any present viable bacterial spores to occur. Then the sample is mixed with a solution of a lanthanide capable of forming a fluorescent complex with dipicolinic acid. Lastly, the sample is measured for the presence of dipicolinic acid.

U.S. Pat. No. 4,847,198 to Wilfred H. Nelson; discloses a method for the identification of a bacterium. Firstly, taxonomic markers are excited in a bacterium with a beam of ultra violet energy. Then, the resonance enhance Raman back scattered energy is collected substantially in the absence of fluorescence. Next, the resonance enhanced Raman back scattered energy is converted into spectra which corresponds to the taxonomic markers in said bacterium. Finally, the spectra are displayed and thus the bacterium may be identified.

U.S. Pat. No. 6,379,920 to Mostafa A. El-Sayed discloses a method to analyze and diagnose specific bacteria in a biological sample by using spectroscopic means. The method includes obtaining the spectra of a biologic sample of a non-infected patient for use as a reference, subtracting the reference from the spectra of an infected sample, and comparing the fingerprint regions of the resulting differential spectrum with reference spectra of bacteria. Using this diagnostic technique, U.S. Pat. No. 6,379,920 claims to identify specific bacteria without culturing.

Naumann et al had demonstrated bacteria detection and classification in dried samples using FTIR spectroscopy [Naumann D. et al., “Infrared spectroscopy in microbiology”, Encyclopedia of Analytical Chemistry, R. A. Meyers (Ed.) pp. 102-131, John Wiley & Sons Ltd, Chichester, 2000.]. Marshall et al had identifies live microbes using FTIR Raman spectroscopy [Marshall et al “Vibrational spectroscopy of extant and fossil microbes: Relevance for the astrobiological exploration of Mars”, Vibrational Spectroscopy 41 (2006) 182-189]. Others methods involve fluorescence spectroscopy of a combination of the above.

None of the prior art literature discloses means and method that can quickly (without culturing) and accurately detect bacteria from a sample, and none demonstrates identification within a wet sample. Furthermore, none of the prior art literature discloses means and method that can eliminate the water influence from the sample so as to better detect the bacteria. Moreover all of the above require a skilled operator and/or the use of reagents or a complicated sample preparation for the detection of bacteria.

Furthermore, none of the above distinguishes among different bacteria in a mixture or within a sample.

Thus, there is a long felt need for means and method for accurate bacteria identification from an uncultured sample and more specifically an aerosol sample without the use of reagents and/or complicated sample preparation.

### SUMMARY OF THE INVENTION

It is one object of the present invention to provide a method for detecting and/or identifying specific bacteria within an uncultured sample; said method comprising:
a. obtaining an absorption spectrum (AS) of said uncultured sample;
b. acquiring the n dimensional volume boundaries for said specific bacteria by
   i. obtaining at least one absorption spectrum (AS2) of known samples containing said specific bacteria;
   ii. extracting x features from said entire AS2; said x features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; x is an integer higher or equal to one; x is an integer greater than or equal to one;
   iii. dividing said AS2 into several segments according to said x features;
   iv. calculating y features of each of said segment of said AS2; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; y is an integer higher or equal to one;
   v. assigning at least one of said x features and/or at least one of said y features to said specific bacteria by algorithms selected from a group consisting of Sequential Backward Selection, Sequential Forward Selection, Sequential Forward Floating Selection (SFFS), Max-Min algorithm, trace(S_{b})/trace(S_{w}); S_{w}/(S_{b}+S_{w}); Kullback-Lieber divergence; correct classification rate; and any combination thereof;
   vi. defining n dimensional space; n equals the sum of said x and said y features;
   vii. defining the n dimensional volume in said n dimensional space; determining said boundaries of said n dimensional volume by using technique selected from a group consisting of Bayes classifier, Support Vector Machine (SVM), Linear discriminant functions and Fisher's linear discriminant, Gaussian Mixed Model (GMM), C4.5 algorithm tree, K-nearest neighbor, Weighted K-nearest neighbor, Hierarchical clustering algorithm, K-mean clustering algorithm, Ward's clustering algorithm, Minimum least square, Neural-Network or any combination thereof;
c. data processing said AS;
   i. noise reducing by using different smoothing techniques selected from a group consisting of running average, savitzky-golay, low pass filter or any combination thereof;
   ii. extracting m features from said entire AS; said m features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m is an integer higher or equal to one;
   iii. dividing said AS into several segments according to said m features;
   iv. calculating m₁ features of each of said segment; said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₁ is an integer greater than or equal to one; and,
d. detecting and/or identifying said specific bacteria if said m₁ features and/or said m features are within said n dimensional volume;
wherein said sample is an aerosol sample selected from a group consisting of cough, sneeze, saliva, mucus, bile, urine, vaginal secretions, middle ear aspirate, pus, pleural effusions, synovial fluid, abscesses, cavity swabs, serum, blood and spinal fluid.

It is another object of the present invention to provide the method for detecting and/or identifying specific bacteria within an uncultured sample as defined above, additionally comprising step of selecting said x feature and/or said y features via algorithms selected form Chi-Squared, χ2, test, Wilcoxon test, and t-test or any combination thereof.

It is another object of the present invention to provide the method for detecting and/or identifying specific bacteria within an uncultured sample as defined above, wherein said step of acquiring the n dimensional volume boundaries for the specific bacteria, additionally comprising step of calculating the Gaussian distribution and/or Multivariate Gaussian distribution, and/or Rayleigh distribution, and/or Maxwell distribution, and/or Estimate the distribution by the Parzen method or mixed model (like the Gaussian Mixed Model known as GMM) for at least one of the n features such that the distributions defines the n dimensional volume in the n dimensional space.

It is another object of the present invention to provide the method for detecting and/or identifying specific bacteria within an uncultured sample as defined above, wherein said step (c) of data processing said AS additionally comprising steps of:
i. calculating at least one of the o^{th} derivative of said AS; said o is an integer greater than or equals 1;
ii. extracting m₂ features from said entire o^{th} derivative spectrum; said m₂ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one;
iii. dividing said o^{th} derivative into several segments according to said m₂ features;
iv. calculating the m₃ features in at least one of said segments; said m₃ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one; and,
v. detecting and/or identifying said specific bacteria if said and/or m₃ features and/or said m and/or said m₂ features are within said n dimensional volume.

It is another object of the present invention to provide the method for detecting and/or identifying specific bacteria within an uncultured sample as defined above, additionally comprising the step of selecting said specific bacteria selected from a group consisting of Streptococcus Pyogenes, Group B, C and G beta-hemolytic streptococci, Corynebacterium haemolyticum pseudodiphtheriticum, Diphtheria and Ulcerans, Neisseria Gonorrhoeae, Mycoplasma Pneumoniae, Yersinia Enterocolitica, Mycobacterium tuberculosis, Chlamydia Trachomatiss and Pneumoniae, Bordetella Pertussis, Legionella spp, Pneumocystis Carinii, Nocardia, Histoplasma Capsulatum, Coccidioides Immitis, Haemophilus influenza group A beta hemolytic, Streptococcus Viridans, streptococcus Pneumonia, Staph epidermidis, Corynebacterium, Moraxella catarrhalis, Klebsiella, Escherichia Coli, staphylococcus Aureus, Streptococcus Bovis, Streptococcus Agalactiae, Streptococcus pneumonia, Staphylococcus epidermidis, Klebsiella pneumonia, E. coli or any combination thereof.

It is another object of the present invention to provide the method for detecting and/or identifying specific bacteria within an uncultured sample as defined above, wherein said step of obtaining the AS additionally comprising steps of:
a. providing at least one optical cell accommodates said uncultured sample;
b. providing p light source selected from a group consisting of laser, lamp, LEDs tunable lasers, monochrimator, p is an integer equal or greater than 1; said p light source are adapted to emit light to said optical cell;
c. providing detecting means for receiving the spectroscopic data of said sample;
d. emitting light from said light source at different wavelengths to said optical cell; and,
e. collecting said light exiting from said optical cell by said detecting means; thereby obtaining said AS.

It is another object of the present invention to provide the method for detecting and/or identifying specific bacteria within an uncultured sample as defined above, wherein said step of emitting light is performed at the wavelength range of UV, visible, IR, mid-IR, far-IR and terahertz.

It is another object of the present invention to provide the method for detecting and/or identifying specific bacteria within an uncultured sample as defined above, additionally comprising the step of detecting said bacteria by analyzing said AS in the region of about 3000-3300 cm⁻¹ and/or about 850-1000 cm⁻¹ and/or about 1300-1350 cm⁻¹, and/or about 2836-2995 cm⁻¹, and/or about 1720-1780 cm⁻¹, and/or about 1550-1650 cm⁻¹, and/or about 1235-1363 cm⁻¹, and/or about 990-1190 cm⁻¹ and/or about 1500-1800 cm⁻¹ and/or about 2800-3050 cm⁻¹ and/or about 1180-1290 cm⁻¹.

It is another object of the present invention to provide a method for detecting and/or identifying specific bacteria within an uncultured sample; said method comprising:
a. obtaining an absorption spectrum (AS) of said uncultured sample; said AS containing water influence;
b. acquiring the n dimensional volume boundaries for said specific bacteria by:
   i. obtaining at least one absorption spectrum (AS2) of known samples containing said specific bacteria;
   ii. extracting x features from said AS2; said x features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; x is an integer higher or equal to one; x is an integer greater than or equal to one;
   iii. calculating at least one derivative of said AS2;
   iv. dividing said AS2 into several segments according to said x features;
   v. calculating the y features of each of said segment; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; y is an integer higher or equal to one;
   vi. assigning at least one of said x features and/or at least one of said y features to said specific bacteria by algorithms selected from a group consisting of Sequential Backward Selection, Sequential Forward Selection, Sequential Forward Floating Selection (SFFS), Max-Min algorithm, trace(S_{b})/trace(S_{w}); S_{w}/(S_{b}+S_{w}); Kullback-Lieber divergence; correct classification rate; and any combination thereof;
   vii. defining n dimensional space; n equals the sum of said x features and said y features;
   viii. defining the n dimensional volume in said n dimensional space;
   ix. determining said boundaries of said n dimensional volume by using technique selected from a group consisting of Bayes classifier, Support Vector Machine (SVM), Linear discriminant functions and Fisher's linear discriminant, Gaussian Mixed Model (GMM), C4.5 algorithm tree, K-nearest neighbor, Weighted K-nearest neighbor, Hierarchical clustering algorithm, K-mean clustering algorithm, Ward's clustering algorithm, Minimum least square, Neural-Network or any combination thereof;
c. eliminating said water influence from said AS by at least one of the following methods: Low pass filter, High pass filter and Water absorption division;
d. data processing said AS without said water influence by
   i. noise reducing by using different smoothing techniques selected from a group consisting of running average savitzky-golay, low pass filter or any combination thereof;
   ii. extracting m features from said entire AS; said m features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m is an integer greater or equal to one;
   iii. dividing said AS into several segments according to said m features;
   iv. calculating the m₁ features of at least one of said segment; said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₁ is an integer greater than or equal to one; and,
e. detecting and/or identifying said specific bacteria if said m₁ features and/or said m features are within said n dimensional volume;
wherein said sample is an aerosol sample selected from a group consisting of cough, sneeze, saliva, mucus, bile, urine, vaginal secretions, middle ear aspirate, pus, pleural effusions, synovial fluid, abscesses, cavity swabs, serum, blood and spinal fluid.

It is another object of the present invention to provide the method for detecting and/or identifying specific bacteria within an uncultured sample as defined above, additionally comprising step of selecting said x feature and/or said y features via algorithms selected form Chi-Squared, χ2, test, Wilcoxon test, and t-test or any combination thereof.

It is another object of the present invention to provide the method for detecting and/or identifying specific bacteria within an uncultured sample as defined above, wherein said step of acquiring the n dimensional volume boundaries for the specific bacteria, additionally comprising step of calculating the Gaussian distribution and/or Multivariate Gaussian distribution, and/or Rayleigh distribution, and/or Maxwell distribution, and/or Estimate the distribution by the Parzen method or mixed model (like the Gaussian Mixed Model known as GMM) for at least one of the n features such that the distributions defines the n dimensional volume in the n dimensional space.

It is another object of the present invention to provide the method for detecting and/or identifying specific bacteria within an uncultured sample as defined above, wherein said step (c) of data processing said AS without said water influence, additionally comprising steps of
i. calculating at least one of the o^{th} derivative of said AS; said o is an integer greater than or equals 1;
ii. extracting m₂ features from said entire o^{th} derivative spectrum; said m₂ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one;
iii. dividing said o^{th} derivative into several segments according to said m₂ features;
iv. calculating the m₃ features in at least one of said segments; said m₃ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one; and,
v. detecting and/or identifying said specific bacteria if said m₁ and/or m₃ features and/or said m and/or said m₂ features are within said n dimensional volume.

It is another object of the present invention to provide the method for detecting and/or identifying specific bacteria within an uncultured sample as defined above, additionally comprising the step of selecting said specific bacteria selected from a group consisting of Streptococcus Pyogenes, Group B, C and G beta-hemolytic streptococci, Corynebacterium haemolyticum pseudodiphtheriticum, Diphtheria and Ulcerans, Neisseria Gonorrhoeae, Mycoplasma Pneumoniae, Yersinia Enterocolitica, Mycobacterium tuberculosis, Chlamydia Trachomatiss and Pneumoniae, Bordetella Pertussis, Legionella spp, Pneumocystis Carinii, Nocardia, Histoplasma Capsulatum, Coccidioides Immitis, Haemophilus influenza group A beta hemolytic, Streptococcus Viridans, streptococcus Pneumonia, Staph epidermidis, Corynebacterium, Moraxella catarrhalis, Klebsiella, Escherichia Coli, staphylococcus Aureus, Streptococcus Bovis, Streptococcus Agalactiae, Streptococcus pneumonia, Staphylococcus epidermidis, Klebsiella pneumonia, E. coli or any combination thereof.

It is another object of the present invention to provide the method for detecting and/or identifying specific bacteria within an uncultured sample as defined above, wherein said step of obtaining the AS additionally comprising steps of:
a. providing at least one optical cell accommodating said uncultured sample;
b. providing p light source selected from a group consisting of laser, lamp, LEDs tunable lasers, monochrimator, p is an integer equal or greater than 1; said p light source are adapted to emit light to said optical cell;
c. providing detecting means for receiving the spectroscopic data of said sample;
d. emitting light from said light source at different wavelength to said optical cell;
e. collecting said light exiting from said optical cell by said detecting means; thereby obtaining said AS.

It is another object of the present invention to provide the method for detecting and/or identifying specific bacteria within an uncultured sample as defined above, wherein said step of emitting light is performed at the wavelength range of UV, visible, IR, mid-IR, far IR and terahertz.

It is another object of the present invention to provide the method for detecting and/or identifying specific bacteria within an uncultured sample as defined above, wherein the absorption spectra is obtained using an instrument selected from the group consisting of a spectrometer, Fourier transform infrared spectrometer, a fluorometer and a Raman spectrometer.

It is another object of the present invention to provide the method for detecting and/or identifying specific bacteria within an uncultured sample as defined above, wherein said aerosol sample is taken from the human body.

It is another object of the present invention to provide a system 1000 adapted to detect and/or identify specific bacteria within an uncultured sample; said system comprising:
a. means 100 for obtaining an absorption spectrum (AS) of said uncultured sample;
b. statistical processing means 200 for acquiring the n dimensional volume boundaries for said specific bacteria; said means 200 are characterized by:
   i. means 201 for obtaining at least one absorption spectrum (AS2) of known samples containing said specific bacteria;
   ii. means 202 for extracting x features from said entire AS2; said x features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance, value of the signal, Skewness value, Kurtosis value, Gaussians' set of parameters (μ,σ,Ai), different peaks' intensity ratios, wavelet coefficients or any combination thereof; x is an integer higher or equal to one;
   iii. means 203 for dividing said AS2 into several segments according to said x features;
   iv. means 204 for calculating y features from at least one of each of said segment; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; y is an integer higher or equal to one;
   v. means 205 assigning at least one of said x features and/or at least one of said y features to said specific bacteria by algorithms selected from a group consisting of Sequential Backward Selection, Sequential Forward Selection, Sequential Forward Floating Selection (SFFS), Max-Min algorithm, trace(S_{b})/trace(S_{w}); S_{w}/(S_{b}+S_{w}); Kullback-Lieber divergence; correct classification rate; and any combination thereof;
   vi. means 206 for defining n dimensional space; n equals the sum of said x features and said y features;
   i. means 207 for defining the n dimensional volume in the n dimensional space;
   vii. means 208 for determining said boundaries of said n dimensional volume by using technique selected from a group consisting of Bayes classifier, Support Vector Machine (SVM), Linear discriminant, functions and Fisher's linear discriminant, Gaussian Mixed Model (GMM), C4.5 algorithm tree, K-nearest neighbor, Weighted K-nearest neighbor, Hierarchical clustering algorithm, K-mean clustering algorithm, Ward's clustering algorithm, Minimum least square, Neural-Network or any combination thereof;
   viii. means 209 for assigning the n dimensional volume to said specific bacteria;
c. means 300 for data processing said AS; said means 300 are characterized by
   i. means 301 for noise reducing by using different smoothing techniques selected from a group consisting of running average savitzky-golay, low pass filter or any combination thereof;
   ii. means 302 for extracting m features from said entire AS; said m features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m is an integer higher or equal to one;
   iii. means 303 for dividing said AS into several segments according to said m features;
   iv. means 304 for calculating the m₁ features of at least one of said segment; said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (ν,σ,Ai), different peaks' intensity ratios, wavelet coefficients or any combination thereof; m₁ is an integer greater than or equal to one; and,
d. means 400 for detecting and/or identifying said specific bacteria if said m₁ features and/or said m features are within said n dimensional volume;
wherein said sample is an aerosol sample selected from a group consisting of cough; sneeze, saliva, mucus, bile, urine, vaginal secretions, middle ear aspirate, pus, pleural effusions, synovial fluid, abscesses, cavity swabs, serum, blood and spinal fluid.

It is another object of the present invention to provide the system as defined above, additionally comprising means for selecting said x feature and/or said y features via algorithms selected form Chi-Squared, χ2, test, Wilcoxon test, and t-test or any combination thereof.

It is another object of the present invention to provide the system 1000 as defined above, wherein said, statistical processing means 200 additionally comprising means 210 for calculating the Gaussian distribution or Multivariate Gaussian distribution; or Rayleigh distribution, or Maxwell distribution, or Estimate the distribution by the Parzen method or by mixed model (like the Gaussian Mixed Model known as GMM) for at least one of the n features such that the distributions defines the n dimensional volume in the n dimensional space.

It is another object of the present invention to provide the system 1000 as defined above, wherein said means 300 for data processing said AS additionally characterized by:
i. means 305 for calculating at least one of the o^{th} derivative of said AS; said o is an integer greater than or equals 1;
ii. means 306 for extracting m₂ features from said entire o^{th} derivative spectrum; said m₂ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one;
iii. means 307 for dividing said o^{th} derivative into several segments according to said m₂ features;
iv. means 308 for calculating the m₃ features in at least one of said segments; said m₃ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one; and,
v. means 309 for detecting and/or identifying said specific bacteria if said m₁ and/or m₃ features and/or said m and/or said m₂ features are within said n dimensional volume.

It is another object of the present invention to provide the system 1000 as defined above, wherein said specific bacteria is selected from a group consisting of Streptococcus Pyogenes, Group B, C and G beta-hemolytic streptococci, Corynebacterium haemolyticum pseudodiphtheriticum, Diphtheria and Ulcerans, Neisseria Gonorrhoeae, Mycoplasma Pneumoniae, Yersinia Enterocolitica, Mycobacterium tuberculosis, Chlamydia Trachomatiss and Pneumoniae, Bordetella Pertussis, Legionella spp, Pneumocystis Carinii, Nocardia, Histoplasma Capsulatum, Coccidioides Immitis, Haemophilus influenza group A beta hemolytic, Streptococcus Viridans, streptococcus Pneumonia, Staph epidermidis, Corynebacterium, Moraxella catarrhalis, Klebsiella, Escherichia Coli, staphylococcus Aureus, Streptococcus Bovis, Streptococcus Agalactiae, Streptococcus pneumonia, Staphylococcus epidermidis, Klebsiella pneumonia, E. coli or any combination thereof.

It is another object of the present invention to provide the system 1000 as defined above, wherein said means 100 for obtaining an absorption spectrum (AS) of said sample additionally comprising:
a. at least one optical cell for accommodating said uncultured sample;
b. p light source selected from a group consisting of laser, lamp, LEDs tunable lasers, monochromator, p is an integer equal or greater than 1; said p light source are adapted to emit light at different wavelength to said optical cell; and,
c. detecting means for receiving the spectroscopic data of said sample exiting from said optical cell.

It is another object of the present invention to provide the system 1000 as defined above, wherein said p light source are adapted to emit light at wavelength range selected from a group consisting of UV, visible, IR, mid-IR, far-IR and terahertz. It is another object of the present invention to provide a system 2000 adapted to detect and/or identify specific bacteria within an uncultured sample; said system 2000 comprising:
a. means 100 for obtaining an absorption spectrum (AS) of said uncultured sample; said AS containing water influence;
b. statistical processing means 200 for acquiring the n dimensional volume boundaries for said specific bacteria; said means 200 are characterized by:
   i. means 201 for obtaining at least one absorption spectrum (AS2) of known samples containing said specific bacteria;
   ii. means 202 for extracting x features from said entire AS2; said x features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; x is an integer higher or equal to one; x is an integer greater than or equal to one;
   iii. means 203 for dividing said AS2 into several, segments according to said x features;
   iv. means 204 for calculating the y features of at least one of said segments; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; y is an integer higher or equal to one;
   v. means 205 for assigning at least one of said x features and/or at least one of said y features to said specific bacteria algorithms selected from a group consisting of Sequential Backward Selection, Sequential Forward Selection, Sequential Forward Floating Selection (SFFS), Max-Min algorithm, trace(S_{b})/trace(S_{w}); S_{w}/(S_{b}+S_{w}); Kullback-Lieber divergence; correct classification rate; and any combination thereof;
   vi. means 206 for defining n dimensional space; n equals the sum of said x features and said y features;
   vii. means 207 for defining the n dimensional volume in said n dimensional space;
   viii. means 208 for determining said boundaries of said n dimensional volume by using technique selected from a group consisting of Bayes classifier, Support Vector Machine (SVM), Linear discriminant, functions and Fisher's linear discriminant, Gaussian Mixed Model (GMM), C4.5 algorithm tree, K-nearest neighbor, Weighted K-nearest neighbor, Hierarchical clustering algorithm, K-mean clustering algorithm, Ward's clustering algorithm, Minimum least square, Neural-Network or any combination thereof;
   i. means 209 for assigning said n dimensional volume to said specific bacteria;
c. means 300 for eliminating said water influence from said AS selected from a group consisting of; Low pass filter, High pass filter and Water absorption division
d. means 400 for data processing said AS without said water influence; said means 400 are characterized by:
   i. means 401 for noise reducing by using different smoothing techniques selected from a group consisting of running average savitzky-golay, low pass filter or any combination thereof;
   ii. means 402 for extracting m features from said entire AS; said m features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m is an integer greater than or equal to one;
   iii. means 403 for dividing said AS into several segments according to said m features;
   iv. means 404 for calculating m₁ features at least one of said segments; said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₁ is an integer greater than or equal to one; and,
e. means 500 for detecting and/or identifying said specific bacteria if said
   m₁ features and/or said m features are within said n dimensional volume; wherein said sample is an aerosol sample selected from a group consisting of cough, sneeze, saliva, mucus, bile, urine, vaginal secretions, middle ear aspirate, pus, pleural effusions, synovial fluid, abscesses, cavity swabs, serum, blood and spinal fluid.

It is another object of the present invention to provide the system as defined above, additionally comprising means for selecting said x feature and/or said y features via algorithms selected form Chi-Squared, χ2, test, Wilcoxon test, and t-test or any combination thereof.

It is another object of the present invention to provide the system 2000 as defined above, wherein said statistical processing means 200 additionally comprising means 210 for calculating the Gaussian distribution or Multivariate Gaussian distribution, or Rayleigh distribution, or Maxwell distribution, or Estimate the distribution by the Parzen method or by mixed model (like the Gaussian Mixed Model known as GMM) for at least one of the n features such that the distributions defines the n dimensional volume in the n dimensional space.

It is another object of the present invention to provide the system 2000 as defined above, wherein said means 400 for data processing said AS without said water influence additionally comprising:
i. means 405 for calculating at least one of the o^{th} derivative of said AS; said o is an integer greater than or equals 1;
ii. means 406 for extracting m₂ features from said entire o^{th} derivative spectrum; said m₂ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one;
iii. means 407 for dividing said o^{th} derivative into several segments according to said m₂ features;
iv. means 408 for calculating the m₃ features from at least one of said segments; said m₃ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one; and,
v. means 409 for detecting and/or identifying said specific bacteria if said m₁ and/or m₃ features and/or said m and/or said m₂ features are within said n dimensional volume.

It is another object of the present invention to provide the system 2000 as defined above, wherein said specific bacteria is selected from a group consisting of Streptococcus Pyogenes, Group B, C and G beta-hemolytic streptococci, Corynebacterium haemolyticum pseudodiphtheriticum, Diphtheria and Ulcerans, Neisseria Gonorrhoeae, Mycoplasma Pneumoniae, Yersinia Enterocolitica, Mycobacterium tuberculosis, Chlamydia Trachomatiss and Pneumoniae, Bordetella Pertussis, Legionella spp, Pneumocystis Carinii, Nocardia, Histoplasma Capsulatum, Coccidioides Immitis, Haemophilus influenza group A beta hemolytic, Streptococcus Viridans, streptococcus Pneumonia, Staph epidermidis, Corynebacterium, Moraxella catarrhalis, Klebsiella, Escherichia Coli, staphylococcus Aureus, Streptococcus Bovis, Streptococcus Agalactiae, Streptococcus pneumonia, Staphylococcus epidermidis, Klebsiella pneumonia, E. coli, or any combination thereof.

It is another object of the present invention to provide the system 2000 as defined above, wherein said means 100 for obtaining an absorption spectrum (AS) of said sample additionally comprising:
a. at least one optical cell for accommodating said uncultured sample;
b. p light source selected from a group consisting of laser, lamp, LEDs tunable lasers, monochrimator, p is an integer equal or greater than 1; said p light source are adapted to emit light at different wavelength to said optical cell; and,
c. detecting means for receiving the spectroscopic data of said sample exiting from said optical cell.

It is another object of the present invention to provide the system 2000 as defined above, wherein said p light source are adapted to emit light at wavelength range selected from a group consisting of UV, visible, IR, mid-IR, far-IR and terahertz. It is another object of the present invention to provide the system 2000 as defined above, wherein the absorption spectra is obtained using an instrument selected from the group consisting of a spectrometer, Fourier transform infrared spectrometer, a fluorometer and a Raman spectrometer.

It is another object of the present invention to provide the system 2000 as defined above, wherein said aerosol sample is taken from the human body.

It is another object of the present invention to provide the system 2000 as defined above, additionally comprising means adapted to recommend, after the specific bacteria has been identified, what kind of antibiotics and medicine to take.

It is another object of the present invention to provide the methods as defined above, additionally comprising step of recommending, after the specific bacteria has been identified, what kind of antibiotics and medicine to take.

It is another object of the present invention to provide the system 2000 as defined above, wherein said sample is an aerosol sample obtained from air moisture and/or contaminations in air condition systems.

It is another object of the present invention to provide the methods as defined above, wherein said sample is an aerosol sample obtained from air moisture and/or contaminations in air condition systems.

It is another object of the present invention to provide the system 2000 as defined above, wherein the sensitivity of said system is less than 6×10⁶ bacteria/μL.

### BRIEF DESCRIPTION OF THE FIGURES

For better understanding the invention and to see how it may be implemented in practice, a plurality of embodiments will now be described, by way of non-limiting example only, with reference to the accompanying drawings, in which

FIGS. 1-2 illustrate a system 1000 and 2000 respectfully for detecting and/or identify bacteria within an aerosol sample according to preferred embodiments of the present invention.

FIGS. 3-4 illustrate an absorption spectrum prior to the water influence elimination (FIG. 3) and after the water influence elimination (FIG. 4) whilst using the first method.

FIGS. 5-7 illustrate the second method for eliminating the water influence.

FIGS. 8-9 illustrate the third method for eliminating the water influence.

FIGS. 10-11 illustrate Streptococcus Type A (Streptococcus Pyogenes) aerosol spectrum and Streptococcus Bovis aerosol spectrum respectfully.

FIG. 12 illustrates the absorption signal of a sample containing 25% streptococcus pyogenes and 75% streptococcus Bovis prior to and after the noise was reduced (recorded signal vs. smoothed signal).

FIG. 13 illustrating the signal's first derivative of a sample containing 25% streptococcus pyogenes and 75% streptococcus. Bovis prior to and after the noise was reduced (recorded signal vs. smoothed signal).

FIG. 14 illustrates the boundaries of a two dimensions area which enable the identification of bacteria.

FIGS. 15a and 15b illustrate bacterial spectral signal at 1237 cm⁻¹ region for different bacteria concentrations (FIG. 15a) and the absorbance as a function of the bacteria concentration (FIG. 15b).

FIGS. 16a and 16b illustrates the bacteria spectral signal at 1084 cm⁻¹ region for different bacteria-concentrations (FIG. 16a) and the absorbance as a function of the bacteria concentration (FIG. 16b).

FIG. 17 illustrates the spectrum of the coughed aerosols taken from a patient suspected to have Strep A.

FIG. 18 illustrates the classification results and separation between patients that were Strep. A. positive and those who were Strep. A. negative.

### DETAILED DESCRIPTION OF THE PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide means and methods for detecting bacteria within a sample by using Spectroscopic measurements.

Spectroscopic measurements, whether absorption fluorescence Raman, and scattering are the bases for all optical sensing devices. In order to identify a hazardous material (for example a bacteria) in an aerosol sample that might contain the material is placed inside a spectrometer and the absorption spectrum of the sample is then analyzed to verify whether the spectral signature of the hazardous material is recognized.

The present invention provides means and methods for detection or identification of bacteria by analyzing the absorption spectra of a sample which might contain bacteria.

The term “sample” refers herein to an aerosol sample. The present invention provides accurate detection means that enable the detection of bacteria in aerosol samples. The detection means can be used for medical or non-medical applications. Furthermore, the detection means can be used, for example, in detecting bacteria in water, beverages, food production, sensing for hazardous materials in crowded places etc.

The aerosol sample will be obtained from coughing, sneezing, saliva, bile, mucus, urine (the aerosols will be done using a spray after sample collection), blood (the aerosols will be done using a spray after sample collection), blood Serum (the aerosols will be done using a spray after sample collection) or spinal fluid (the aerosols will be done using a spray after sample collection), vaginal secretions, middle ear aspirate, pus, pleural effusions, synovial fluid, abscesses, cavity swabs, serum.

Furthermore, the aerosol samples will be obtained from air moisture (hazardous materials such as soot, metals) and contaminations in air condition and ventilations systems.

The present invention will provides means and method for detecting hazardous materials such as anthrax, chemical agents such as VX, sarin et cetera by sampling the air in suspected places.

The term “High-pass filter (HPF)” refers hereinafter to a filter that passes high frequencies well, but attenuates (reduces the amplitude of) frequencies lower than a cutoff frequency.

The term “Low-pass filter (LPF)” refers hereinafter to a filter that passes low-frequency signals but attenuates (reduces the amplitude of) signals with frequencies higher than a cutoff frequency.

The term “Chi-Squared, χ2, test” refers hereinafter to any statistical hypothesis test in which the sampling distribution of the test statistic is a chi-square distribution when the null hypothesis is true, or any in which this is asymptotically true, meaning that the sampling distribution (if the null hypothesis is true) can be made to approximate a chi-square distribution as closely as desired by making the sample size large enough.

The term “Pearson's correlation coefficient” refers hereinafter to the correlation between two variables that reflects the degree to which the variables are related. Pearson's correlation reflects the degree of linear relationship between two variables. It ranges from +1 to −1. A correlation of −1 means that there is a perfect negative linear relationship between variables. A correlation of 0 means there is no linear relationship between the two variables. A correlation of 1 means there is a complete linear relationship between the two variables.

A commonly used formula for computing Pearson's correlation coefficient r is the following one:

$$r = \frac{Σ XY - \frac{Σ X Σ Y}{N}}{\sqrt{( Σ {X}^{2} - \frac{{( Σ X )}^{2}}{N} ) ( Σ {Y}^{2} - \frac{{( Σ Y )}^{2}}{N} )}}$$

The term “about” refers hereinafter to a range of 25% below or above the referred value.

The term “segments” refers hereinafter to wavelength ranges within the absorption spectrum.

The term “n dimensional volume” refers hereinafter to a volume in an n dimensional space that is especially adapted to identify the bacteria under consideration. The n dimensional volume is constructed by extracting features and correlations from the absorption spectrum or its derivatives.

The term “n dimensional space” refers hereinafter to a space where each coordinate is a feature extracted from the bacteria spectral signature or calculated out of the spectrum and its derivatives or from a segment of the spectrum and/or its derivatives. The term “n dimensional volume boundaries” refers hereinafter to a range that includes about 95% of the bacteria under consideration possible features and correlation values.

The term “trace(S_{b})/trace(S_{w})” refers hereinafter to the ratio between interclass and intraclass covariance matrix. It refers to a method used to measure the separability of two classes. It relates to the ability to achieve high correct classification in a designed classifier. In the following disclosure S_{b} is the covariance matrix reflecting the distance between two classes, and S_{w} is covariance matrix reflecting the distance within class.

The term “Correlation” refers herein after to correlation between the aerosol bacteria spectrum and a reference bacteria spectrum which is already known, correlation between bacteria spectrum without the water influence and a reference bacteria spectrum which is already known, correlation between o^{th} derivative of the aerosol bacteria spectrum and a reference bacteria spectrum which is already known, correlation between o^{th} derivative of the bacteria spectrum without the water influence and a reference bacteria spectrum which is already known. o is an integer greater than or equals to 1. The above correlations are calculated on the whole spectrum and/or segments of the spectrum and/or their derivatives.

Methods and means for bacteria detection adapted to utilize the unique spectroscopic signature of microbes/bacteria/hazardous materials and thus enables the detection of the microbes/bacteria/hazardous materials within, a sample are provided by the present invention.

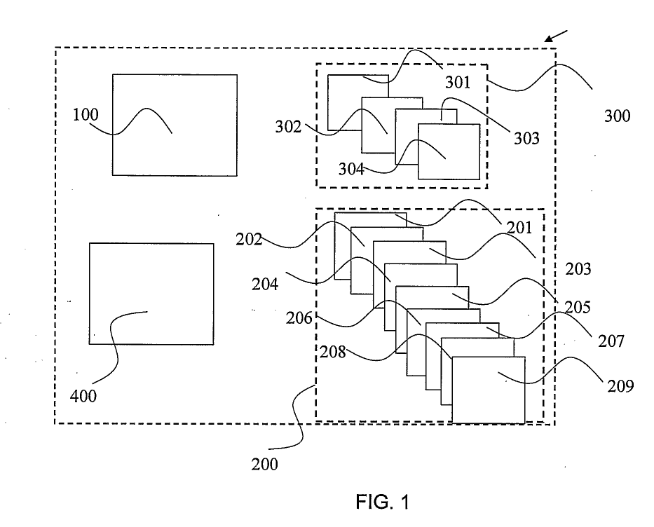

Reference is now made to FIG. 1, illustrating a system 1000 adapted to detect and/or identify specific bacteria within a sample according to one preferred embodiment of the present invention. System 1000 comprises:
a. means 100 for obtaining an absorption spectrum (AS) of the sample;
b. statistical processing means 200 for acquiring the n dimensional volume boundaries of at least specific bacteria, having:
   i. means 201 for obtaining at least one absorption spectrum (AS2) of known samples containing the specific bacteria;
   ii. means 202 for extracting x features from the entire AS2; said x features are selected from a group consisting of Correlation peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (ν,σ,Ai), different peaks' intensity ratios, wavelet coefficients or any combination thereof; x is an integer higher or equal to one;
   iii. means 203 for dividing the AS2 into several segments according to at least one of the x features;
   iv. means 204 for extracting y features from at least one of said segments; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; y is an integer higher or equal to one;
   v. means 205 for assigning at least one of said x features and/or at least one of said y features to said specific bacteria by algorithms selected from a group consisting of Sequential Backward Selection, Sequential Forward Selection, Sequential Forward Floating Selection (SFFS), Max-Min algorithm, trace(S_{b})/trace(S_{w}); S_{w}/(S_{b}+S_{w}); Kullback-Lieber divergence; correct classification rate; and any combination thereof;
   vi. means 206 for defining n dimensional space; n equals the sum of the x and y;
   vii. means 207 for defining the n dimensional volume in the n dimensional space;
   viii. means 208 for determining the boundaries of the n dimensional volume by using technique selected from a group consisting of Bayes classifier, Support Vector Machine (SVM), Linear discriminant, functions and Fisher's linear discriminant, Gaussian Mixed Model (GMM), C4.5 algorithm tree, K-nearest neighbor, Weighted K-nearest neighbor, Hierarchical clustering algorithm, K-mean clustering algorithm, Ward's clustering algorithm, Minimum least square, Neural-Network or any combination thereof;
   ix. means 209 for assigning the n dimensional volume to the specific bacteria;
c. means 300 for data processing the AS, having:
   i. means 301 for noise reducing by using different smoothing techniques selected from a group consisting of running average savitzky-golay, low pass filter or any combination thereof;
   ii. means 302 for extracting m features from the entire AS; said m features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m is an integer higher or equal to one;
   iii. means 303 for dividing the AS into several segments according to the m features;
   iv. means 304 for extracting m₁ features from at least one of said segments; said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₁ is an integer greater than or equal to one; and,
d. means 400 for detecting and/or identifying the specific bacteria if the m₁ and/or m features are within the n dimensional volume.

According to another embodiment of the present invention, the system as defined above additionally comprising means for selecting said x feature and/or said y features via algorithms selected form Chi-Squared, χ2, test, Wilcoxon test, and t-test or any combination thereof.

According to another embodiment of the present invention, the statistical processing means 200 additionally comprising means 210 (not illustrated in the figures) for calculating the Gaussian distribution or Multivariate Gaussian distribution, or Rayleigh distribution, or Maxwell distribution, Estimate the distribution by the Parzen method or mixed model (like the Gaussian Mixed Model known as GMM) for at least one of the n features such that the distributions defines the n dimensional volume in the n dimensional space.

According to another embodiment of the present invention, means 300 (in system 1000) for data processing the AS additionally characterized by:
i. means 305 (not illustrated in the figures) for calculating at least one of the o^{th} derivative of the AS; o is an integer greater than or equals 1;
ii. means 306 (not illustrated in the figures) for extracting m₂ features from the entire o^{th} derivative spectrum; said m₂ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean, value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one;
iii. means 307 (not illustrated in the figures) for dividing the o^{th} derivative into several segments according to the m₂ features;
iv. mean 308 (not illustrated in the figures) for extracting m₃ features from at least one of said segments; said m₃ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one; and,
v. means 309 (not illustrated in the figures) for detecting and/or identifying the specific bacteria if the m₁ and/or m₃ and/or the m and/or the m₂ features are within the n dimensional volume.

According to yet another embodiment of the present invention, the specific bacteria to be identified by system 1000 is selected from a group, consisting of Streptococcus Pyogenes, Group B, C and G beta-hemolytic streptococci, Corynebacterium haemolyticum pseudodiphtheriticum, Diphtheria and Ulcerans, Neisseria Gonorrhoeae, Mycoplasma Pneumoniae, Yersinia Enterocolitica, Mycobacterium tuberculosis, Chlamydia, Trachomatiss and Pneumoniae, Bordetella Pertussis, Legionella spp, Pneumocystis Carinii, Nocardia, Histoplasma Capsulatum, Coccidioides Immitis, Haemophilus influenza group A beta hemolytic, Streptococcus Viridans, streptococcus Pneumonia, Staph epidermidis, Corynebacterium, Moraxella catarrhalis, Klebsiella, Escherichia Coli, staphylococcus Aureus, Streptococcus Bovis, Streptococcus Agalactiae, Streptococcus pneumonia, Staphylococcus epidermidis, Klebsiella pneumonia, E. coli or any combination thereof.

According to another embodiment of the present invention, the means 100 for obtaining an absorption spectrum (AS) of the sample (in system 1000), additionally comprising:
a. at least one optical cell for accommodating the sample;
b. p light source selected from a group consisting of laser, lamp, LEDs tunable lasers, monochrimator, p is an integer equal or greater than 1; the p light source are adapted to emit light at different wavelength to the optical cell; and,
c. detecting means for receiving the spectroscopic data of the sample exiting from the optical cell.

According to yet another embodiment of the present invention, the p light source (in system 1000) are adapted to emit light at wavelength range selected from a group consisting of UV, visible, IR, mid-IR, far-IR and terahertz.

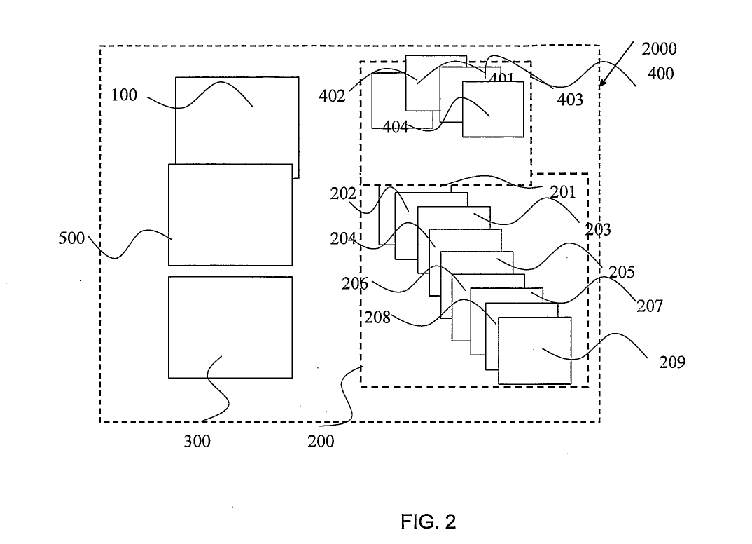

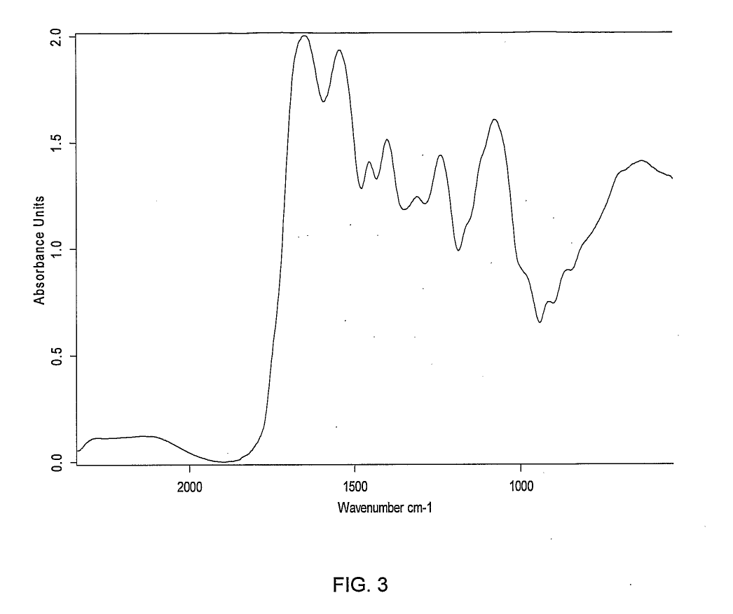

Reference is now made to FIG. 2, illustrating a system 2000 adapted to detect and/or identify specific bacteria within a sample, according to another preferred embodiment of the present invention. System 2000 comprises:
a. means 100 for obtaining an absorption spectrum (AS) of the sample; the AS containing water influence;
b. statistical processing means 200 for acquiring the n dimensional volume boundaries for at least one specific bacteria, having:
   i. means 201 for obtaining at least one absorption spectrum (AS2) of known samples containing the specific bacteria;
   i. means 202 for extracting x features from the entire AS2; said x features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; x is an integer higher or equal to one; x is an integer greater than or equal to one;
   ii. means 203 for dividing the AS2 into several segments according to at least one of the x features;
   iii. means 204 for extracting y features from at least one of said segments; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; y is an integer higher or equal to one;
   iv. means 205 for assigning at least one of said x features and/or at least one of said y features to said specific bacteria by algorithms selected from a group consisting of Sequential Backward Selection, Sequential Forward Selection, Sequential Forward Floating Selection (SFFS), Max-Min algorithm, trace(S_{b})/trace(S_{w}); S_{w}/(S_{b}+S_{w}); Kullback-Lieber divergence; correct classification rate; and any combination thereof;
   v. means 206 for defining n dimensional space; n equals the sum of the x and y;
   vi. means 207 for defining the n dimensional volume in said n dimensional space;
   vii. means 208 for determining the boundaries of the n dimensional volume by using technique selected from a group consisting of Bayes classifier, Support Vector Machine (SVM), Linear discriminant, functions and Fisher's linear discriminant, Gaussian Mixed Model (GMM), C4.5 algorithm tree, K-nearest neighbor, Weighted K-nearest neighbor, Hierarchical clustering algorithm, K-mean clustering algorithm, Ward's clustering algorithm, Minimum least square, Neural-Network or any combination thereof;
   viii. means 209 for assigning the n dimensional volume to the specific bacteria;
c. means 300 for eliminating the water influence from the AS, selected from a group consisting of; Low pass filter, High pass filter and Water absorption division;
d. means 400 for data processing the AS without the water influence, characterized by:
   i. means 401 for noise reducing by using different smoothing techniques selected from a group consisting of running average savitzky-golay, low pass filter or any combination thereof;
   ii. means 402 for extracting m features from the entire AS; said m features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m is an integer greater or equal to one;
   iii. means 403 for dividing the AS into several segments according to the m features;
   iv. means 404 for extracting m₁ features from at least one of said segments; said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₁ is an integer greater than or equal to one; and,
e. means 500 for detecting and/or identifying the specific bacteria if the m₁ and/or m features are within the n dimensional volume.

According to another embodiment of the present invention, the system as defined above additionally comprising means for selecting said x feature and/or said y features via algorithms selected form Chi-Squared, χ2, test, Wilcoxon test, and 1-test or any combination thereof.

According to another embodiment of the present invention, the statistical processing means 200 in system 2000) additionally comprising means 210 (not illustrated in the figures) for calculating the Gaussian distribution or Multivariate Gaussian distribution; or Rayleigh distribution, or Maxwell distribution, Estimate the distribution by the Parzen method or mixed model (like the Gaussian Mixed Model known as GMM) for at least one of the n features such that the distributions defines the n dimensional volume in the n dimensional space.

According to another embodiment of the present invention, means 400 (in system 2000) for data processing the AS without the water influence additionally comprising:
ii. means 405 (not illustrated in the figures) for calculating at least one of the o^{th} derivative of the AS; o is an integer greater than or equals 1;
iii. means 406 (not illustrated in the figures) for extracting m₂ features from the entire o^{th} derivative spectrum; said m₂ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one;
iv. means 407 (not illustrated in the figures) for dividing the o^{th} derivative into several segments according to the m₂ features;
v. mean 408 (not illustrated in the figures) for extracting m₃ features from at least one of said segment; said m₃ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one; and,
vi. means 409 (not illustrated in the figures) for detecting and/or identifying the specific bacteria if the m₁ and/or m₃ and/or the m and/or the m₂ features are within the n dimensional volume.

According to another embodiment of the present invention, the specific bacteria (in system 2000) is selected from a group consisting of Streptococcus Pyogenes, Group B, C and G beta-hemolytic streptococci, Corynebacterium haemolyticum pseudodiphtheriticum, Diphtheria and Ulcerans, Neisseria Gonorrhoeae, Mycoplasma Pneumoniae, Yersinia Enterocolitica, Mycobacterium tuberculosis, Chlamydia Trachomatiss and Pneumoniae, Bordetella Pertussis, Legionella spp, Pneumocystis Carinii, Nocardia, Histoplasma Capsulatum, Coccidioides Immitis, Haemophilus influenza group A beta hemolytic, Streptococcus Viridans streptococcus Pneumonia, Staph epidermidis, Corynebacterium, Moraxella catarrhalis, Klebsiella, Escherichia Coli, staphylococcus Aureus, Streptococcus Bovis, Streptococcus Agalactiae, Streptococcus pneumonia, Staphylococcus epidermidis, Klebsiella pneumonia, E. coli or any combination thereof.

According to another embodiment of the present invention, means 100 for obtaining an absorption spectrum (AS) of the sample additionally comprising:
a. at least one optical cell for accommodating the sample;
b. p light source selected from a group consisting of laser, lamp, LEDs tunable lasers, monochrimator, p is an integer equal or greater than 1; p light source are adapted to emit light at different wavelength to the optical cell; and,
c. detecting means for receiving the spectroscopic data of the sample exiting from the optical cell.

According to yet another embodiment of the present invention, the p light source are adapted to emit light at wavelength range selected from a group consisting of UV, visible, IR, mid-IR, far-IR and terahertz.

Yet another object of the present invention is to provide a method for detecting and/or identifying specific bacteria within a sample. The method comprises step selected inter alia from:
a. obtaining an absorption spectrum (AS) of the sample;
b. acquiring the n dimensional volume boundaries for the specific bacteria by:
   i. obtaining at least one absorption spectrum (AS2) of samples containing the specific bacteria;
   ii. extracting x features from the entire AS2; said x features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; x is an integer higher or equal to one; x is an integer greater than or equal to one;
   iii. dividing the AS2 into several segments according to the x features;
   iv. extracting y features from of each of the segment of AS2; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; y is an integer higher or equal to one;
   v. assigning at least one of said x features and/or at least one of said y features to said specific bacteria by algorithms selected from a group consisting of Sequential Backward Selection, Sequential Forward Selection, Sequential Forward Floating Selection (SFFS), Max-Min algorithm, trace(S_{b})/trace(S_{w}); S_{w}/(S_{b}+S_{w}); Kullback-Lieber divergence; correct classification rate; and any combination thereof;
   vi. defining n dimensional space; n equals the sum of the x features and/or the y features;
   vii. defining the n dimensional volume in said n dimensional space;
   viii. determining the boundaries of the n dimensional volume by using technique selected from a group consisting of Bayes classifier, Support Vector Machine (SVM), Linear discriminant, functions and Fisher's linear discriminant, Gaussian Mixed Model (GMM), C4.5 algorithm tree, K-nearest neighbor, Weighted K-nearest neighbor, Hierarchical clustering algorithm, K-mean clustering algorithm, Ward's clustering algorithm, Minimum least square, Neural-Network or any combination thereof.
c. data processing the AS;
   i. noise reducing by using different smoothing techniques selected from a group consisting of running average savitzky-golay, low pass filter or any combination thereof;
   ii. extracting m features from the entire AS; said m features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or, any combination thereof; m is an integer higher or equal to one;
   iii. dividing the AS into several segments according to the m features;
   iv. calculating the m₁ features of at least one of the segments; said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₁ is an integer greater than or equal to one; and,
d. detecting and/or identifying the specific bacteria if the m₁ and/or the m features are within the n dimensional volume.
   It is another object of the present invention to provide the method for detecting and/or identifying specific bacteria within an uncultured sample as defined above, additionally comprising step of selecting said x feature and/or said y features via algorithms selected form Chi-Squared, χ2, test, Wilcoxon test, and t-test or any combination thereof.

It should be pointed out that in each of the systems or methods as described above (either 1000 or 2000), the statistical processing means 200 is used only once for each specific bacteria. Once the boundaries were provided by the statistical processing means 200 the determination whether the specific bacteria is present in a sample is performed by verifying whether the m and/or m₂ features are within the boundaries. Furthermore, once the boundaries were provided, there exists no need for the statistical processing of the same specific bacteria again.

It should be further pointed out that according to one embodiment of the present invention, either one of the systems (1000 and/or 2000) as defined above can additionally comprise means adapted to recommend any physician, after the specific bacteria has been identified, what kind of antibiotics and medicine to take.

Yet another object of the present invention is to provide a method for detecting and/or identifying specific bacteria within a sample. The method comprises steps selected inter alia from:
a. obtaining an absorption spectrum (AS) of the sample; the AS containing water influence;
b. acquiring the n dimensional volume boundaries for the specific bacteria by:
   i. obtaining at least one absorption spectrum (AS2) of known samples containing the specific bacteria;
   ii. extracting x features from the entire AS2; said x features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; x is an integer higher or equal to one; x is an integer greater than or equal to one;
   iii. dividing the AS2 into several segments according to the x features;
   iv. Extracting y features from of each of the segment of AS2; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; y is an integer higher or equal to one;
   v. assigning at least one of said x features and/or at least one of said y features to said specific bacteria algorithms selected from a group consisting of Sequential Backward Selection, Sequential Forward Selection, Sequential Forward Floating Selection (SFFS), Max-Min algorithm, trace(S_{b})/trace(S_{w}); S_{w}/(S_{b}+S_{w}); Kullback-Lieber divergence; correct classification rate; and any combination thereof;
   vi. defining n dimensional space; n equals the sum of the x features and/or they;
   vii. determining the boundaries of the n dimensional volume by using technique selected from a group consisting of Bayes classifier, Support Vector Machine (SVM), Linear discriminant, functions and Fisher's linear discriminant, Gaussian Mixed Model (GMM), C4.5 algorithm tree, K-nearest neighbor, Weighted K-nearest neighbor, Hierarchical clustering algorithm, K-mean clustering algorithm, Ward's clustering algorithm, Minimum least square, Neural-Network or any combination thereof;
c. eliminating the water influence from the AS by at least one of the following methods: Low pass filter, High pass filter and Water absorption division;
d. data processing the AS without the water influence by:
   i. noise reducing by using different smoothing techniques selected from a group consisting of running average savitzky-golay, low pass filter or any combination thereof;
   ii. extracting m features from the entire AS; said m features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m is an integer greater or equal to one;
   iii. dividing the AS into several segments according to the m features;
   iv. calculating the m₁ features of each of the segment; said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₁ is an integer greater than or equal to one; and,
e. detecting and/or identifying the specific bacteria if the m₁ and/or the m features are within the n dimensional volume.

In each of the methods as described above, the statistical processing is used only once for each specific bacteria. Once the boundaries were provided by the statistical processing the determination whether the specific bacteria is present in a sample is performed by verifying whether the m₁ and/or said m features are within the boundaries. Furthermore, once the boundaries were provided, there exists no need for the statistical processing of the same specific bacteria again.

Furthermore, an additional step of selecting said x feature and/or said y features via algorithms selected form Chi-Squared, χ2, test, Wilcoxon test, and t-test or any combination thereof.

According to another embodiment of the present invention, the step of acquiring the n dimensional volume boundaries for the specific bacteria in each of the methods as defined above, additionally comprising step of calculating the Gaussian distribution and/or Multivariate Gaussian distribution, and/or Rayleigh distribution, and/or Maxwell distribution, and/or Estimate the distribution by the Parzen method or by mixed model (like the Gaussian Mixed Model known as GMM).

for at least one of the n features such that the distributions defines the n dimensional volume in the n dimensional space.

According to another embodiment of the present invention step (c) of data processing the AS, in the methods as described above, additionally comprising steps of:
i. calculating at least one of the o^{th} derivative of the AS; o is an integer greater than or equals 1;
ii. extracting m₂ features from the entire o^{th} derivative spectrum; said m₂ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one;
iii. dividing the o^{th} derivative into several segments according to the m₂ features;
iv. calculating the m₃ features in at least one of the segments; said m₃ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one; and,
v. detecting and/or identifying the specific bacteria if the m₁ and/or m₃ features and/or the m and/or the m₂ features are within the n dimensional volume.

According to another embodiment of the present invention, the methods as described above, additionally comprising the step of selecting the specific bacteria selected from a group consisting of Streptococcus Pyogenes, Group B, C and G beta-hemolytic streptococci, Corynebacterium haemolyticum pseudodiphtheriticum, Diphtheria and Ulcerans, Neisseria Gonorrhoeae, Mycoplasma Pneumoniae, Yersinia Enterocolitica, Mycobacterium tuberculosis, Chlamydia Trachomatiss and Pneumoniae, Bordetella Pertussis, Legionella spp, Pneumocystis Carinii, Nocardia, Histoplasma Capsulatum, Coccidioides Immitis, Haemophilus influenza group A beta hemolytic, Streptococcus Viridans, streptococcus Pneumonia, Staph epidermidis, Corynebacterium, Moraxella catarrhalis, Klebsiella, Escherichia Coli, staphylococcus Aureus, Streptococcus Bovis, Streptococcus Agalactiae, Streptococcus pneumonia, Staphylococcus epidermidis, Klebsiella pneumonia, E. coli or any combination thereof.

According to another embodiment of the present invention, the step of obtaining the AS, in the methods as described above, additionally comprising the following steps:
a. providing at least one optical cell accommodates the sample;
b. providing p light source selected from a group consisting of laser, lamp, LEDs tunable lasers, monochrimator, p is an integer equal or greater than 1; p light source are adapted to emit light to the optical cell;
c. providing detecting means for receiving the spectroscopic data of the sample;
d. emitting light from the light source at different wavelength to the optical cell; and,
e. collecting the light exiting from the optical cell by the detecting means; thereby obtaining the AS.

According to another embodiment of the present invention, the step of emitting light is performed at the wavelength range of UV, visible, IR, mid-IR, far-IR and terahertz. According to another embodiment of the present invention, the methods as defined above, additionally comprising the step of detecting the bacteria by analyzing the AS in the region of about 3000-3300 cm⁻¹ and/or about 850-1000 cm⁻¹ and/or about 1300-1350 cm⁻¹, and/or about 2836-2995 cm⁻¹, and/or about 1720-1780 cm⁻¹, and/or about 1550-1650 cm⁻¹, and/or about 1235-1363 cm¹, and/or about 990-1190 cm⁻¹ and/or about 1500-1800 cm⁻¹ and/or about 2800-3050 cm⁻¹ and/or about 1180-1290 cm⁻¹.

According to yet another embodiment of the present invention, the absorption spectra, in any of the systems (1000 or 2000) or for any of the methods as described above, is obtained using an instrument selected from the group consisting of a spectrometer, Fourier transform infrared spectrometer, a fluorometer and a Raman spectrometer.

According to yet another embodiment of the present invention, the uncultured sample, in any of the systems (1000 or 2000) or for any of the methods as described above, is selected from fluid originated from the human body such as blood, saliva, urine, bile, vaginal secretions, middle ear aspirate, pus, pleural effusions, synovial fluid, abscesses, cavity swabs, mucous, and serum.

It should be further pointed out that according to one embodiment of the present invention, either one of the methods as described above can additionally comprise step of recommending, after the specific bacteria has been identified, what kind of antibiotics and medicine to take.

In the foregoing description, embodiments of the invention, including preferred embodiments, have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

### EXAMPLES

Examples are given in order to prove the embodiments claimed in the present invention. The examples describe the manner and process of the present invention and set forth the best mode contemplated by the inventors for carrying out the invention, but are not to be construed as limiting the invention.

### Example 1

### Water Influence

One of the major problems in identifying bacteria from a fluid sample's spectrum (and especially an aerosol spectrum) is the water influence (i.e., the water noise which masks the desired spectrum by the water spectrum).

The water molecule may vibrate in a number of ways. In the gas state, the vibrations involve combinations of symmetric stretch (v1), asymmetric stretch (v3) and bending (v2) of the covalent bonds. The water molecule has a very small moment of inertia on rotation which gives rise to rich combined vibrational-rotational spectra in the vapor containing tens of thousands to millions of absorption lines. The water molecule has three vibrational modes x, y and z. The following table (table 1) illustrates the water vibrations, wavelength and the assignment of each vibration:

TABLE 1
water vibrations, wavelength and the assignment of each vibration

| | | |
|---|---|---|
| Wavelength | cm−1 | Assignment |

| | | | |
|---|---|---|---|
| 0.2 | mm | 50 | intermolecular bend |
| 55 | μm | 183.4 | intermolecular stretch |
| 25 | μm | 395.5 | L1, librations |
| 15 | μm | 686.3 | L2, librations |
| 6.08 | μm | 1645 | v2, bend |
| 4.65 | μm | 2150 | v2 + L2 b |
| 3.05 | μm | 3277 | v1, symmetric stretch |
| 2.87 | μm | 3490 | v3, asymmetric stretch |
| 1900 | nm | 5260 | av1 + v2 + bv3; a + b = 1 |
| 1470 | nm | 6800 | av1 + bv3; a + b = 2 |
| 1200 | nm | 8330 | av1 + v2 + bv3; a + b = 2 |
| 970 | nm | 10310 | av1 + bv3; a + b = 3 |
| 836 | nm | 11960 | av1 + v2 + bv3; a + b = 3 |
| 739 | nm | 13530 | av1 + bv3; a + b = 4 |
| 660 | nm | 15150 | av1 + v2 + bv3; a + b = 4 |
| 606 | nm | 16500 | av1 + bv3; a + b = 5 |
| 514 | nm | 19460 | av1 + bv3; a + b = 6 |

a and b are integers, ≧0 ms.

The present invention provides a method for significantly reducing and even eliminating the water influence within the absorption spectra.

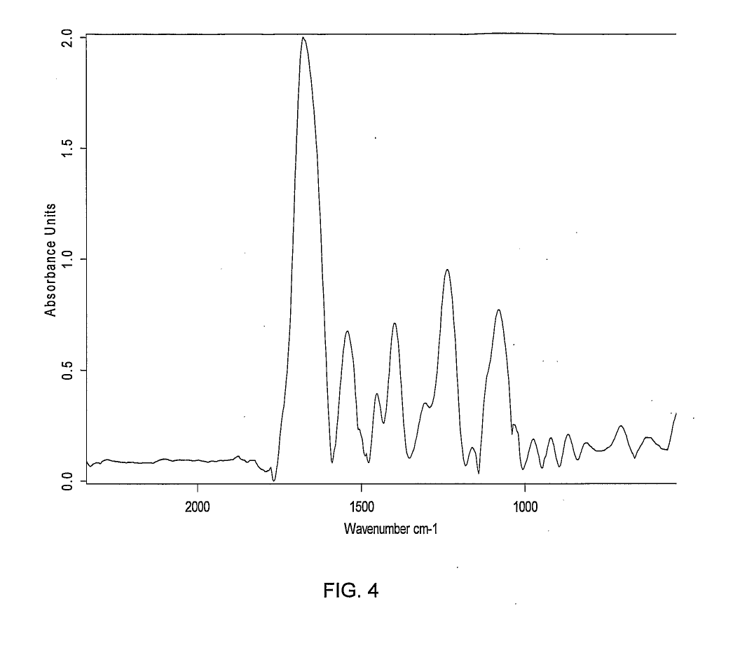

Reference is now made to FIGS. 3 and 4 which illustrate an absorption spectrum of a sample with and without the water influence.

The present invention provides three main methods for eliminating the water influence.

### The First Method

The first method for eliminating the water influence uses Water absorption division and contains the following steps:

First the absorption spectrum was divided into several segments (i.e., wavelength ranges). The spectrum was divided into the following segments (wavenumber ranges) about 1800 cm⁻¹ to about 2650 cm⁻¹, about 1400 cm⁻¹ to about 1850 cm⁻¹, about 1100 cm⁻¹ to about 1450 cm⁻¹, about 950 cm⁻¹ to about 1100 cm⁻¹, about 550 cm⁻¹ to about 970 cm⁻¹.

The segments were determined according to (i) different intensity peaks within the water's absorption spectrum; and, (ii) the signal's trends.

Next, the water influence was eliminated from each segment according to the following protocol:
(a) providing the absorption intensity at each of wavenumber (x) within the absorption spectrum (refers hereinafter as Sig_{with water}(x));
(b) calculating the correction factors (CF) at each wavelength (refers hereinafter as x) within each segment (refers hereinafter as CF(x));
(c) acquiring from the absorption spectrum, at least one absorption intensity that is mainly influenced by water (refers hereinafter as Sig_{water only}(x1)) at the corresponding wavenumbers (x1);
(d) calculating at least one correction factor of the water (CF_{water only} (x1)) at said at least one wavenumber (x1);
(e) dividing at least one Sig_{water only}(x1) by at least one CF_{water} (i.e., Sig_{water only}(x1)/CF_{water only}(x1)) at said at least one wavenumber (x1);
(f) calculating the average of the results of step (e) (refers hereinafter as AVG[Sig_{water only}(x1)/CF_{water only}(x1)]);
(g) multiplying the AVG[Sig_{water only}(x1)/CF_{water only}] (x1) by CF(x) for each wavenumber (x); and,
(h) Subtracting each result of step (g) from Sig_{with water}(x) per each (x).

In other words, each absorption intensity within the spectrum is eliminated from the water influence according to the following equation:

Sig_{with water}(x)−(CF(x)*AVG[Sig_{water only}(x1)/CF_{water only}(x1)])

### Calculating the Correction Factors

The correction factors (CF) depends on the wavelength range, the water absorption peak's shape at each wavelength, peak's width, peak's height, absorption spectrum trends and any combination thereof. The following series were used as a correction factor (x—denote the wavenumber in cm⁻¹)
1. Wavelength range 1846 cm⁻¹ to 2613 cm⁻¹
Coefficients:
a11=137.2;
b11=2170;
c11=224.3;
a21=19.02;
b21=2063;
c21=37.53;
a31=0.7427;
b31=2224;
c31=13;
a41=98.33;
b41=2124;
c41=109.8;
a51=−4.988;
b51=2192;
c51=33.87;
a61=20.19;
b61=1998;
c61=40.22;
a71=228.3;
b71=1496;
c71=1329;
a81=6.751e+012;
b81=−1226;
c81=592.1;

CF(x)=a11*e^{(-((x-b11)/c11)}^{²}⁾+a21*e^{(-((x-b21)/c21)}^{²}⁾+a31*e^{(-((x-b31)/c31)}^{²}⁾+a41*e^{(-((x-b41)/c41)}^{²}⁾+a51*e^{(-((x-b51)/c51)}^{²}⁾+a61*e^{(-((x-b61)/c61)}^{²}⁾+a71*e^{(-((x-b71)/c71)}^{²}⁾+a81*e^{(-((x-b81)/c81)}^{²}⁾
2. Wavelength range 1461 cm⁻¹ to 1846 cm⁻¹
a12=−300.2;
b12=1650;
c12=13.65;
a22=−51.65;
b22=1665;
c22=6.48;
a32=142.4;
b32=1623;
c32=7.584;
a42=1450;
b42=1649;
c42=32.62;
a52=96.34;
b52=1617;
c52=2.387;
a62=608;
b62=1470;
c62=369.3;
a72=0;
b72=1873;
c72=2.625;
a82=1037;
b82=1644;
c82=76.21;

CF(x)=a12*e^{(-((x-b12)/c21)}^{²}⁾+a22*e^{(-((x-b22)/c22)}^{²}⁾+a32*e^{(-((x-b32)/c32)}^{²}⁾+a42*e^{(-((x-b42)/c42)}^{²}⁾+a52*e^{(-((x-b52)/c52)}^{²}⁾+a62*e^{(-((x-b62)/c62)}^{²}⁾+a72*e^{(-((x-b72)/c72)}^{²}⁾+a82*e^{(-((x-b82)/c82)}^{²}⁾
3. Wavelength range 1111 cm⁻¹ to 1461 cm⁻¹
a13=1368;
b13=2167;
c13=767;
a23=80.67;
b23=1356;
c23=68.83;
a33=36.85;
b33=1307;
c33=33.79;
a43=142.5;
b43=1244;
c43=67.19;
a53=260.4;
b53=1130;
c53=88.91;
a63=66.54;
b63=1093;
c63=31;
a73=7.126;
b73=1345;
c73=20.9;
a83=4.897;
b83=1280;
c83=11.05;

CF(x)=a13*e^{(-((x-b13)/c13)}^{²}⁾+a23*e^{(-((x-b23)/c23)}^{²}⁾+a33*e^{(-((x-b33)/c33)}^{²}⁾+a43*e^{(-((x-b43)/c43)}^{²}⁾+a53*e^{(-((x-b53)/c53)}^{²}⁾+a63*e^{(-((x-b63)/c63)}^{²}⁾+a73*e^{(-((x-b73)/c73)}^{²}⁾+a83*e^{(-((x-b83)/c83)}^{²}⁾
4. Wavelength range 961 cm⁻¹ to 1111 cm⁻¹
a14=692.6;
b14=952;
c14=31.04;
a24=48.46;
b24=983.2;
c24=15.72;
a34=287.5;
b34=994.6;
c34=27.98;
a44=434.9;
b44=1032;
c44=40.86;
a54=17.05;
b54=1052;
c54=13.55;
a64=48.61;
b64=1068;
c64=16.56;
a74=70.71;
b74=1086;
c74=21.23;
a84=497.3;
b84=1124;
c84=64.42;

CF(x)=a14*e^{(-((x-b14)/c14)}^{²}⁾+a24*e^{(-((x-b24)/c24)}^{²}⁾+a34*e^{(-((x-b34)/c34)}^{²}⁾+a44*e^{(-((x-b44)/c44)}^{²}⁾+a54*e^{(-((x-b54)/c54)}^{²}⁾+a64*e^{(-((x-b64)/c64)}^{²}⁾+a74*e^{(-((x-b74)/c74)}^{²}⁾+a84*e^{(-((x-b84)/c84)}^{²}⁾
Wavelength range 570 cm⁻¹ to 961 cm⁻¹
a15=−2877;
b15=36.23;
c15=29.09;
a25=0;
b25=−124.3;
c25=22.09;
a35=−190.7;
b35=18.97;
c35=16.45;
a45=1.589e+004;
b45=−3.427;
c45=56.25;
a55=−1.352e+004;
b55=−5.861;
c55=40.75;
a65=476.7;
b65=82.38;
c65=17.29;
a75=1286;
b75=62.29;
c75=180.3;
a85=802.9;
b85=102.8;
c85=18.79;

CF(x)=a15*e^{(-((x-b15)/c15)}^{²}⁾+a25*e^{(-((x-b25)/c25)}^{²}⁾+a35*e^{(-((x-b35)/c35)}^{²}⁾+a45*e^{(-((x-b45)/c45)}^{²}⁾+a55*e^{(-((x-b55)/c55)}^{²}⁾+a65*e^{(-((x-b65)/c65)}^{²}⁾+a75*e^{(-((x-b75)/c75)}^{²}⁾+a85e^{(-((x-b85)/c85)}^{²}⁾

### Absorption Intensity Mainly Influenced by Water

Reference is made again to FIG. 3 which illustrate the absorption spectrum prior to eliminating the water influence.

As can be seen from the figure, the absorption intensity that is mainly influenced by the water is the wavenumber region of 2000 cm⁻¹ and above. The intensity at that region is about 0.2 absorption units. In the present example, x1 is 2000 and Sig_{water only}(x1) is 0.2.

Reference is made again to FIG. 4, which illustrate the absorption spectrum of a sample after the influence of the water was eliminated.

It should be pointed out that for the purpose of obtaining a better resolution both graphs (3 and 4) are normalized to 2 (i.e., multiplied by 2).

### The Second Method

The second method uses a low pass filter, LPF. The method comprises the following steps:
1. Selecting the entire spectrum or at least one sub-region of the fully-hydrated bacteria spectrum.
2. Computing a water-baseline spectrum estimate by filtering the selected fully-hydrated bacteria spectrum by a Low-Pass-Filter (LPF).
3. Subtracting the water-baseline spectrum estimate from the selected fully-hydrated bacteria spectrum to obtain the non-smoothed sole bacteria spectrum.
4. A smoothed version of the sole bacteria spectrum is obtained by applying any smoothing operator like Savitzky-Golay, but not limited, on the non-smoothed sole bacteria spectrum.

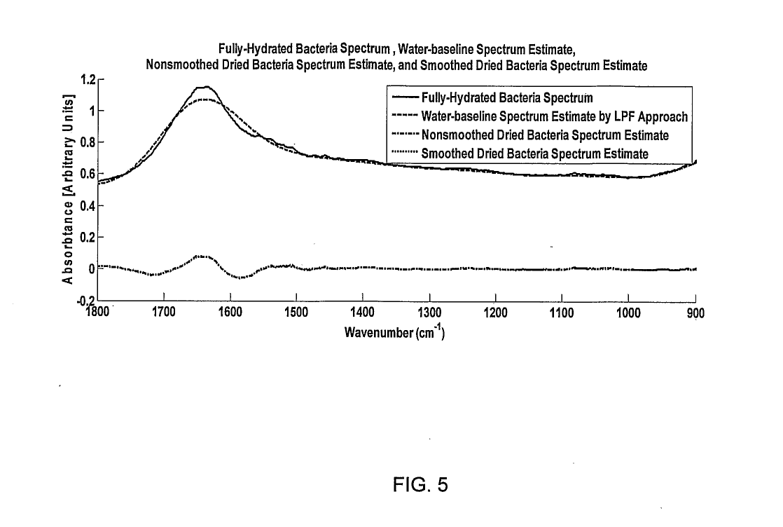

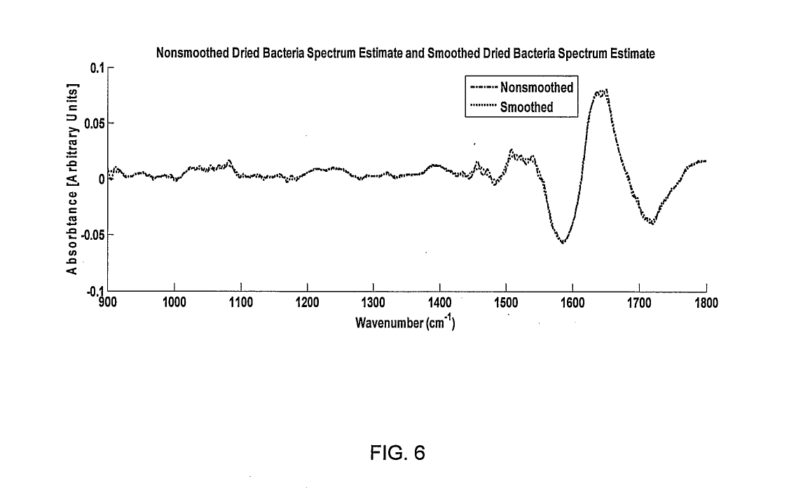

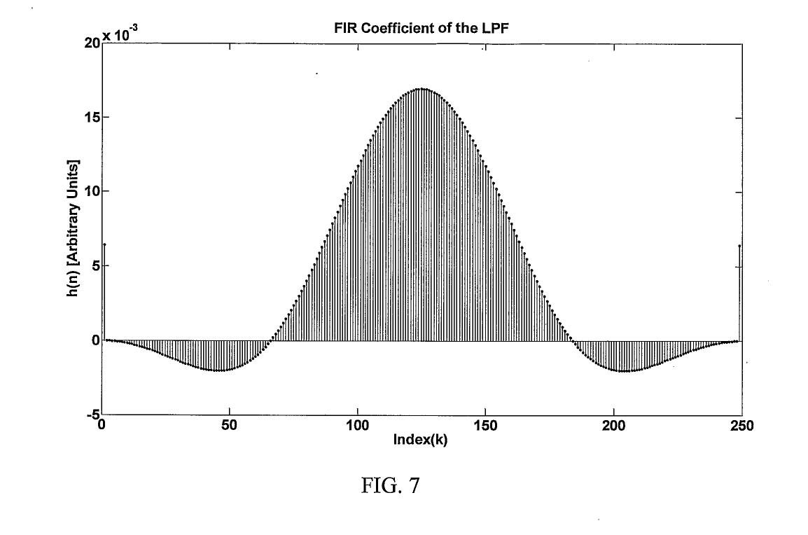

All the steps described above (in the second method) are illustrated in FIGS. 5-7. FIG. 5 illustrates steps 1-4. FIG. 6 illustrates the subtracted non smoothed signal and the subtracted smoothed signal. FIG. 7 illustrates Finite-Impulse-Response (FIR) used to generate the LPF coefficients.

### The Third Method

The third method uses a high pass filter, HPF. The method comprises the following steps:
1. Selecting the entire spectrum or a sub-region of the fully-hydrated bacteria spectrum.
2. Computing the sole bacteria spectrum by filtering the selected fully-hydrated bacteria spectrum by a High-Pass-Filter (HPF).
3. Subtracting the sole bacteria spectrum from the entire spectrum to obtain the non-smoothed sole bacteria spectrum.
4. A smoothed version of the sole bacteria spectrum is obtained by applying any smoothing operator like Savitzky-Golay, but not limited, on the non-smoothed sole bacteria spectrum.

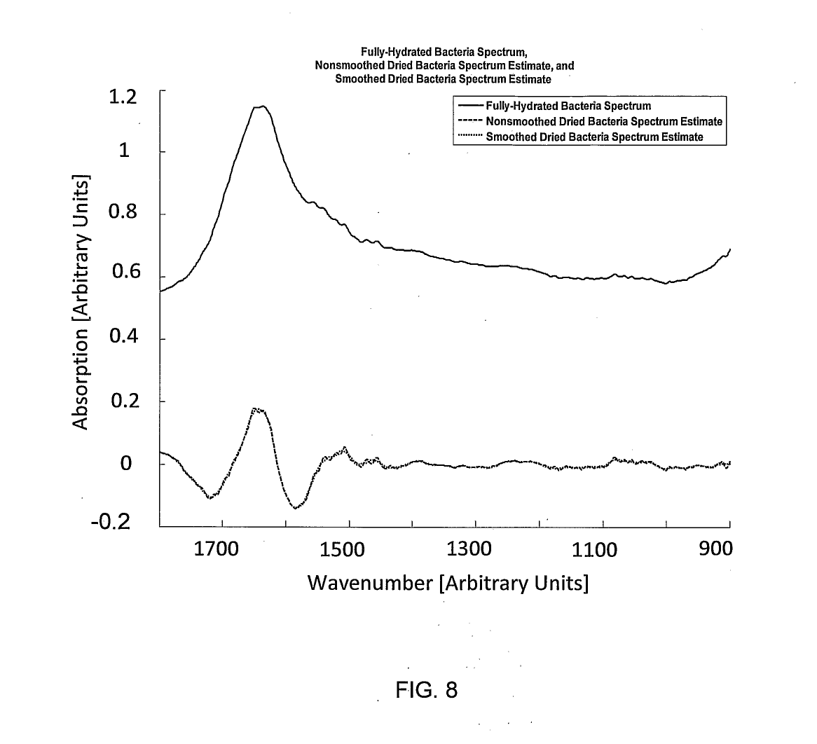

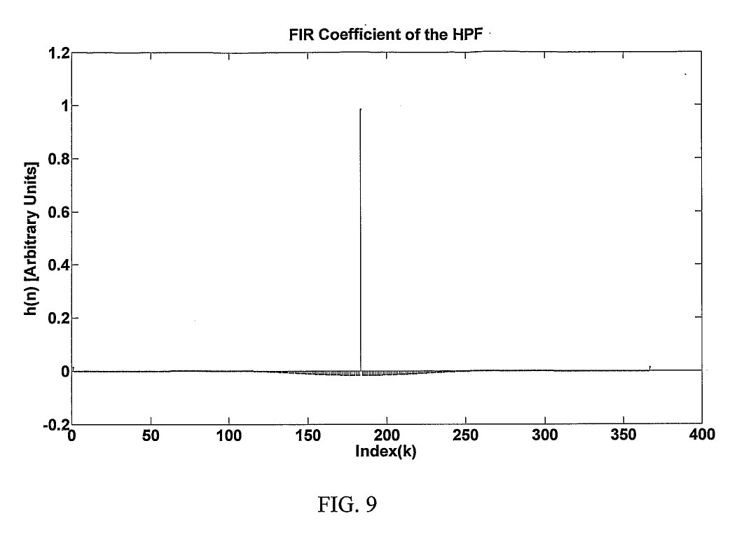

All the steps described above (in the third method) are illustrated in FIGS. 8-9. FIG. 8 illustrates steps 1-4. FIG. 9 illustrates Finite-Impulse-Response (FIR) used to generate the HPF coefficients.

### Example 2

### Bacteria's Absorption Spectrum

Each type of bacteria has a unique spectral signature. Although many types of bacteria have similar spectral signatures there are still some spectral differences that are due to different proteins on the cell membrane and differences in the DNA/RNA structure. The following protocol was used:
1. Strep. β hemolytic (ATCC 19615) were purchased from HY labs.
2. The content of one full plate that was grass seeded with Strep. Pyo by adding 800 μL, of ddH2O to the plate and collecting the content into 1 eppendorf tube 500 μl.
3. Centrifuge the tube for 5 minX14000 rpm
4. Discarding the supernatant
5. Adding 30 μL of ddW solution.
6. Mixing the content;
7. Reference reading of the empty optical cell
8. Putting 500 μL of the tube in a 3 mL spray bottle
9. Spraying one practice squeeze into an eppendorf tube and discarding the tube
10. Spraying 2 squeezes: one on one side, and the other in the other side of the optical cell.
11. Placing the optical cell to the optical system and reading the spectral signature in the optical system.

The same protocol was used for the other bacteria as well.

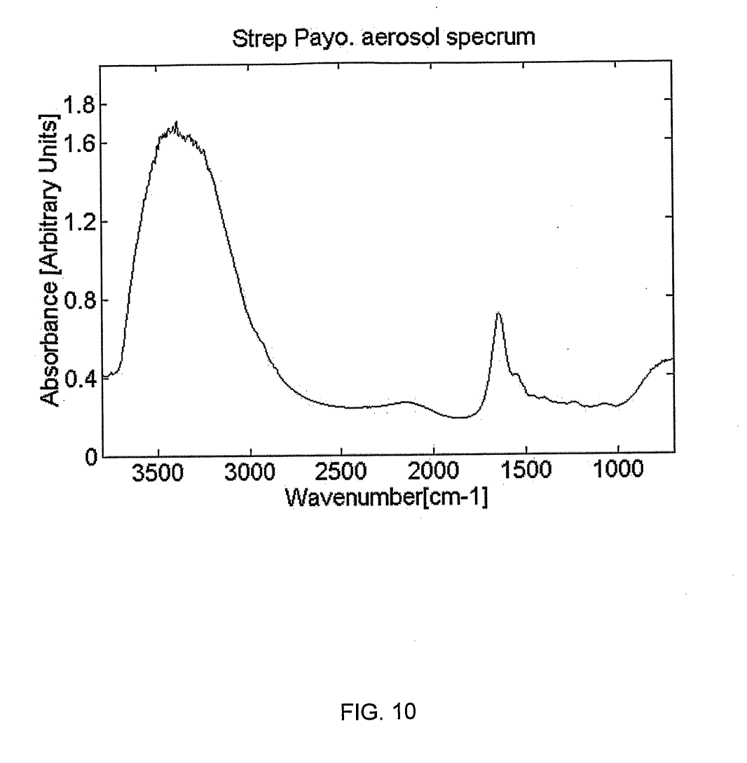

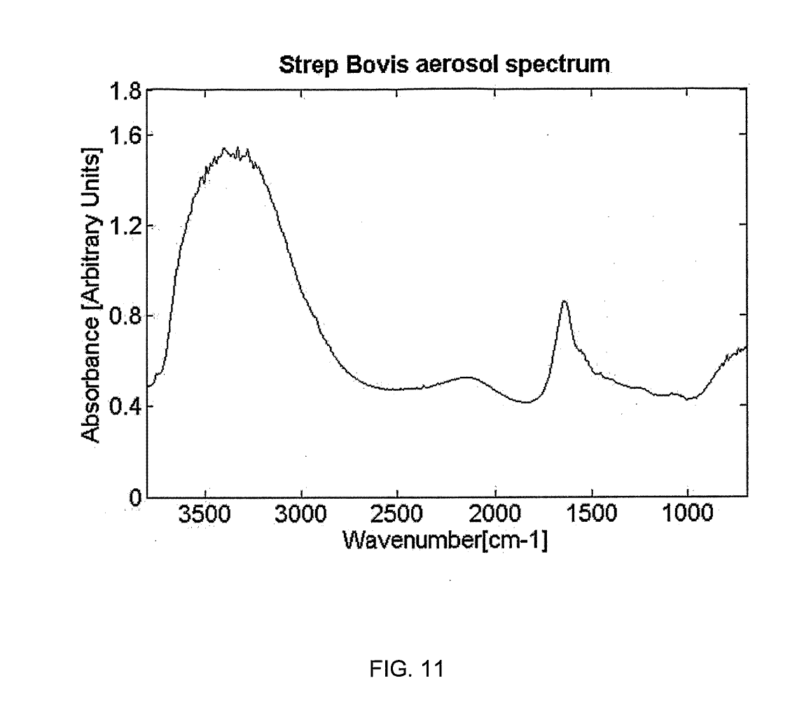

The following figures show the absorption spectrum of bacteria in aerosols. Reference is now made to FIGS. 10-11 illustrating Streptococcus Type A (Streptococcus Pyogenes) aerosol spectrum and Streptococcus Bovis aerosol spectrum respectfully.

### Example 3

### Distinguishing Between Two Bacteria in an Aerosol Sample

The following examples illustrate in-vitro examples to provide a method to distinguish between two bacteria within an aerosol mixture of—Streptococcus payogenes and Streptococcus Bovis and to identify and/or determine whether Streptococcus payogenes is present within the aerosol sample.

The following protocol was used:
1. Strep. β hemolytic (ATCC 19615) and Streptococcus bovis (ATCC 9809) were purchased from HY labs.
2. The content of two full plates of Strep pyo. is added with 800 μL of ddH2O to each plate and the content is placed into eppendorf tube. The procedure is repeated twice (collecting the content of 6 full plates to 3 eppendorf tubes).
3. Step 2 is repeated for S. bovis, collecting the content of 8 full plates to 4 eppendorf tubes.
4. Centrifuging the 4 tubes 3 min×9,000 rpm.
5. Discarding the supernatant.
6. Weighting the four eppendorf tubes.
7. Transferring with 1 ml ddH2O the bacteria pellets to each tube (one for S. pyogenes and one for S. bovis).
8. Centrifuging the tubes 3 min×9,000 rpm.
9. Discarding the supernatant into two eppendorf tubes
10. Weighting the 2 eppendorf tubes with bacteria pellet.
11. Calculating weight of bacteria pellet as can be seen for example in the following table.

TABLE 2
bacteria pellet's weight.

| | Weight of | Weight of tube with | Weight of |
|---|---|---|---|
| | empty tube | bacterial pellet | bacterial pellet |
| 1 | 1.03862 gr | 1.13035 gr | 91.73 mg S. pyogenes |
| 2 | 1.04102 gr | 1.13343 gr | 92.41 mg S. bovis |

12. Adding 917 μl of ddH2O to S. pyogenes tube and the same amount to S. bovis tube. The S. pyogenes and S. bovis concentration: 1×10⁸/μl.
12. Mixing the content.
13. Preparing mixtures of S. pyogenes and S. bovis in 3 ml spray bottle according for example to the following table.

TABLE 3
different mixtures of S. pyogenes and S. bovis.

| | | Volume of | | Volume of |
|---|---|---|---|---|
| Number | % of | S. pyogenes | % of | S. bovis |
| of tube | S. pyogenes | solution (μl) | S. bovis | solution (μl) |
| 1 | 100 | 360 | 0 | 0 |
| 2 | 75 | 270 | 25 | 90 |
| 3 | 50 | 180 | 50 | 180 |
| 4 | 25 | 90 | 75 | 270 |
| 5 | 0 | 0 | 100 | 360 |

13. Reference reading of the optical cell.
14. Spraying two practice squeezes into an eppendorf tube and discarding the tube
15. Spraying two squeezes into the optical cell from each side of the cell in a biological hood.
16. placing the optical cell to the optical system.
17. Reading the spectral signature in the optical system.

The identification and/or detection of specific bacteria was as follows:
(a) The water influence was eliminated using methods selected inter alia from, but not limited, low pass filter, high pass filter, and water absorption division to receive the dry bacteria spectrum estimate.
(b) the noise in each of the absorption spectra (without the water influence) was reduced by using Savitzky-Golay smoothing;
(c) m features such as, but not limited to, Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof were extracted from the spectra. A total of m features were extracted. m is an integer higher or equals 1;
(d) the signal was divided into several regions (segments, i.e., several wavenumber regions) according to said m features;
(e) m/features were extracted from at least one of the spectrum's regions. said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₁ is an integer greater than or equal to one.
(f) the m features and the m₁ features were examined and checked whether they are within the n dimensional volume boundaries (which acquired by the statistical processing);
(g) the identification of the specific bacteria was determined as positive if the m features and/or the m₁ features are within the n dimensional volume boundaries.

### Statistical Processing

The statistical processing is especially adapted to provide the n dimensional volume boundaries. For each specific bacterium the statistical processing was performed only once, for obtaining the boundaries. Once the boundaries were provided, the determination whether the specific bacteria is present in a sample was as explained above (i.e., verifying whether the feature vector are within the boundaries). The statistical processing for each specific bacterium is performed in the following manner:
(a) obtaining several absorption spectrum (AS2) of known samples containing the specific bacteria;
(b) extracting x features from the signal such as, but not limited to, said x features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; x is an integer higher or equal to one A total of x features. x is an integer higher or equals 1;
(c) dividing the signal into several regions (segments) according to said x features;
(d) Calculating y features for at least one of the segments within the absorption spectrum; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; y is an integer higher or equal to one;
(e) assigning at least one of said x features and/or at least one of said y features to said specific bacteria algorithms selected from a group consisting of Sequential Backward Selection, Sequential Forward Selection, Sequential Forward Floating Selection (SFFS), Max-Min algorithm, trace(S_{b})/trace(S_{w}); S_{w}/(S_{b}+S_{w}); Kullback-Lieber divergence; correct classification rate; and any combination thereof;
(f) Defining n dimensional space. n equals the sum of the x features and y features;
(g) Assigning and/or interlinking each one of the x and y features, to the specific bacteria which its identification is required;
(h) Optionally calculating the statistical distribution for each of the x and y features (thus, defining the n dimensional volume) and,
(i) Determining the boundaries of each volume by using a classifier or a combination of classifiers (for example k nearest neighbor, Bayesian classification et cetera).

It should be pointed out that the assignment of at least one of the x features and/or at least one of the y features to the specific bacteria is performed by method of feature selection and classification.

It should be pointed out that the method can additionally comprise step of selecting said x feature and/or said y features via algorithms selected form Chi-Squared, χ2, test, Wilcoxon test, and t-test or any combination thereof.

It should be further pointed out that the Gaussian distribution or Multivariate Gaussian distribution, or Rayleigh distribution, or Maxwell distribution, or Estimate the distribution by the Parzen method or by or mixed model (like the Gaussian Mixed Model known as GMM) for at least one of the n features such that the distributions defines the n dimensional volume in the n dimensional space.

It should be further emphasized that all the above mentioned steps could be performed on at least one of the o^{th} derivative of the absorption spectrum; o is an integer greater than or equals 1. e.g. the features are extracted from the o^{th} derivative instead of the signal.

If the features (extracted from the spectrum and/or its derivatives) are within the n dimensional volume boundaries, the specific bacteria is identified. Otherwise the bacteria are not identified.

Alternatively or additionally, each of the x and/or y features are given a weighting factor. The weighting factor is determined by the examining how each feature improves the bacteria detection prediction (for example by using maximum likelihood or Bayesian estimation). Once the weighting factor is assigned to each one of the x and y features the boundaries are determined for the features having the most significant contribution to the bacteria prediction.

Alternatively or additionally, the AS2 and its derivatives is smoothed by reducing the noise. The noise reduction is obtained by different smoothing techniques selected from a group consisting of running average savitzky-golay or any combination thereof.

The following is an illustration of the two dimensional boundary based on the two best features from a segment of the spectrum.

### Smoothing of the Spectrum

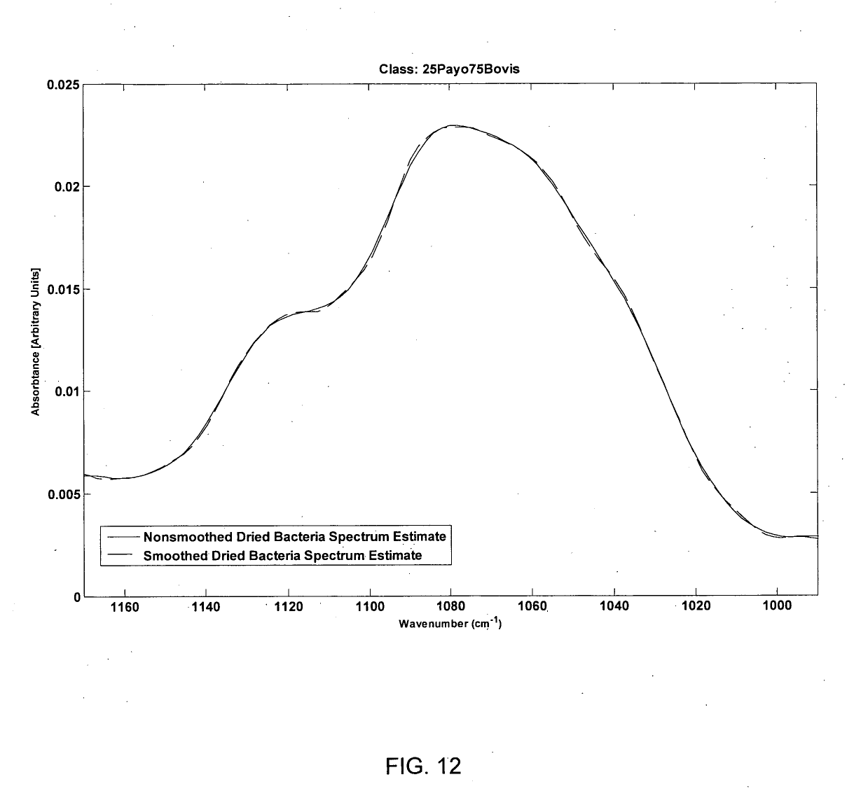

Reference is now made to FIG. 12 illustrating the absorption signal of a sample containing 25% streptococcus pyogenes and 75% streptococcus Bovis prior to and after the noise was reduced (recorded signal vs. smoothed signal).

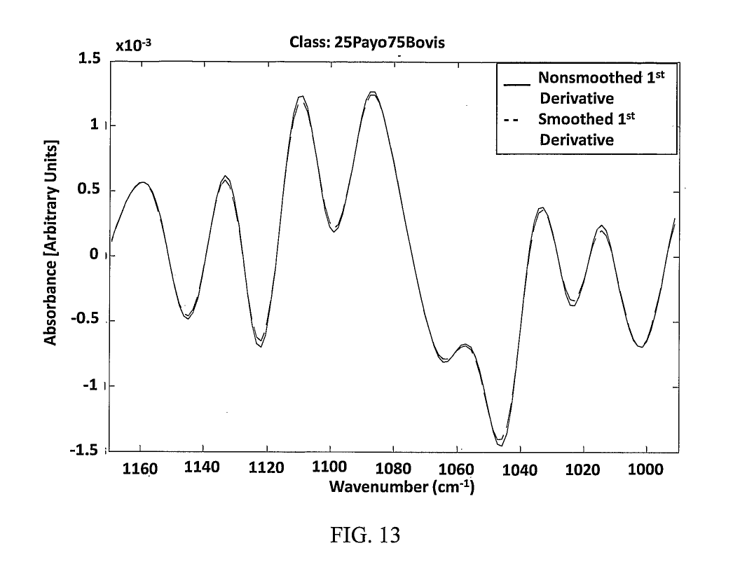

Reference is now made to FIG. 13 illustrating the signal's first derivative of a sample containing 25% streptococcus pyogenes and 75% streptococcus Bovis prior to and after the noise was reduced (recorded signal vs. smoothed signal).

The m Features Extracted from the Spectrum

The following m features were extracted:

peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof. m is an integer greater or equal to one.

The features were extracted from (i) the dried bacteria spectrum (i.e., after the water influence was eliminated), (ii) First derivative of the wet bacteria spectrum (prior to the water influence elimination), (iii) Second derivative of the wet bacteria spectrum, (iv) First derivative of the dried bacteria spectrum (i.e., after the water influence was eliminated), (v) Second derivative of the dried bacteria spectrum estimate (i.e., after the water influence was eliminated), (vi) Correlation.

Other features that were extracted were Peak's wave length and height of the wet bacteria spectrum, Peak's wave length and height of the dried bacteria spectrum estimate, Peak Width from a peak's wave length of the wet bacteria spectrum, Peak Width from a peak's wave length of the dried bacteria spectrum estimate, Peak Width from a specified wavenumber of the wet bacteria spectrum, Peak Width from a specified wavenumber of the dried bacteria spectrum estimate.

The signal and the signal's first derivative were divided to following segments 3000-3300 cm⁻¹, about 850-1000 cm⁻¹ about 1300-1350 cm⁻¹, about 2836-2995 cm⁻¹, about 1720-1780 cm⁻¹, about 1550-1650 cm⁻¹, about 1235-1363 cm⁻¹, about 990-1190 cm⁻¹ about 1500-1800 cm⁻¹ about 2800-3050 cm⁻¹ about 1180-1290 cm⁻¹ according to said features due to the fact that in these regions there were differences between the specific bacteria to be detected (i.e., streptococcus pyogenes) and other bacteria (e.g., streptococcus bovis).

The m₁ features were extracted from at least one of the above mentioned spectrum segments.

The two most significant features found to be the wavelet transform coefficients calculated on the wavenumber region [990-1170] (cm⁻¹), where the wavelet family was the Daubechies Wavelets (db2).

Feature #1 is coefficient # 7 (denotes as cA3(7)) in the approximation of level # 3 with db2 wavelet transform, where db2 is the Daubechies family wavelet of order 2 (denotes as column X in the following table), and Feature #2 is coefficient # 6 (denotes as cD3(6)) in the detail of level # 3 with db2 wavelet transform, where db2 is the Daubechies family wavelet of order 2 (denotes as column X in the following table).

The selection of these features stem from the fact that they yield the best discrimination power in identifying between the fully-hydrated bovis bacteria and the fully-hydrated mixed-strep-with-bovis bacteria.

In the following table different samples containing different amounts of Strep-Payo bacteria and Strep-Bovis. It should be pointed out that the number preceding the bacteria name is the percent of mixed between the strep bacteria and bovis bacteria; for instance 25 Payo75Bovis means that the underlying sample contains of 25% Strep-Payo bacteria and 75% of Strep-Bovis bacteria.

TABLE 4
different samples containing different amounts of
Strep-Payo bacteria and Strep-Bovis

| | | Feature | Feature |
|---|---|---|---|
| # | Bacteria Class | X | Y |
| 1 | 25Payo75Bovis | −0.771 | 0.5962 |
| 2 | 50Payo50Bovis | −0.6264 | −0.5753 |
| 3 | 75Payo25Bovis | −1.031 | −1.6437 |
| 4 | Payo 100% | −0.863 | −0.4382 |
| 5 | Bovis | 1.9373 | 0.2952 |

### Boundaries Calculations

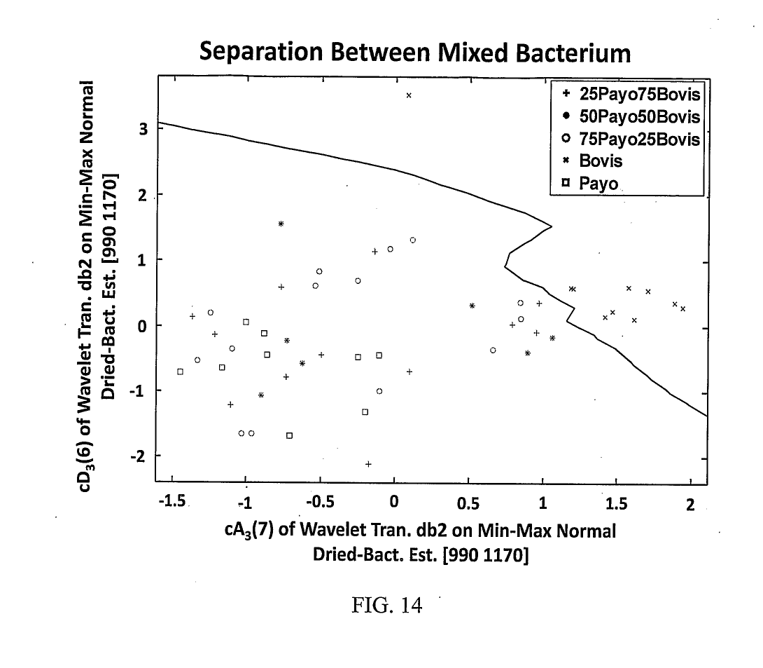

As explained above, the boundaries are calculated according to the features which had the most significant contribution for the specific bacteria identification in the sample. Reference is now made to FIG. 14 which illustrate the boundaries of a two dimensions area which enable the identification of bacteria. As mentioned above, the boundaries were calculated based on the two features having the significant contribution to the bacteria prediction which are coefficient # 7 and coefficient # 6; whilst using 1-Nearest-Neighbor classifier.

As can be, seen from the FIG. 14, when streptococcus is present in the sample, it is possible to optically determine and identify its presence within the sample.

Verification Whether the Features or Correlation are within the Boundaries

Once a sample for detection is obtained (for example, a sample containing 50% strep pyo.), the absorption signal is read, the water influence is eliminated and the features are extracted. Then, according to the features one can determine whether strep. pyo. is present in the sample.

As can be seen from the above and table samples that contain streptococcus fall in the region left to the division line.

For example let us look at a sample containing 50% streptococcus pyogenes and 50% streptococcus Bovis. The wavelet coefficients are −0.6264 and −0.5753 for the first and second features respectively. This point falls on the left side of the line (boundary) in the graph. Therefore, strep. pyo. is identified within the sample.

As another example let us look at a sample containing 100% streptococcus Bovis (i.e. does not contain streptococcus payogenes). The wavelet coefficients are 1.9373 and 0.2952 for the first and second features respectively. This point falls on the right side of the line in the graph. Therefore, strep. pyo. is not present in the sample.

It should be pointed out that the present invention detects bacteria as whole and not just single proteins on the membrane.

### Example 4

### Sensitivity Measurements

Sensitivity at 1237 cm⁻¹

One of the most important characteristics of the system is its sensitivity.

The term “sensitivity” refers hereinafter as the ability to detect diluted amounts of bacteria.

We measured spectral signature of the bacteria at different bacterial solution concentrations and computed the system sensitivity. At each concentration we sprayed into the optical cell about 40 μL of bacteria solution in the form of aerosol.

The aerosols occupy 0.03% of the optical cell volume.

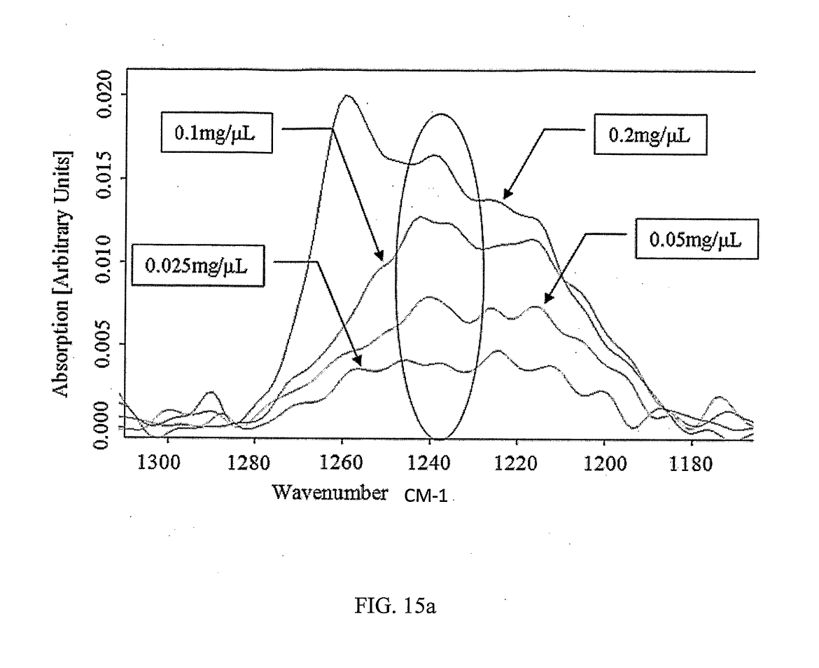

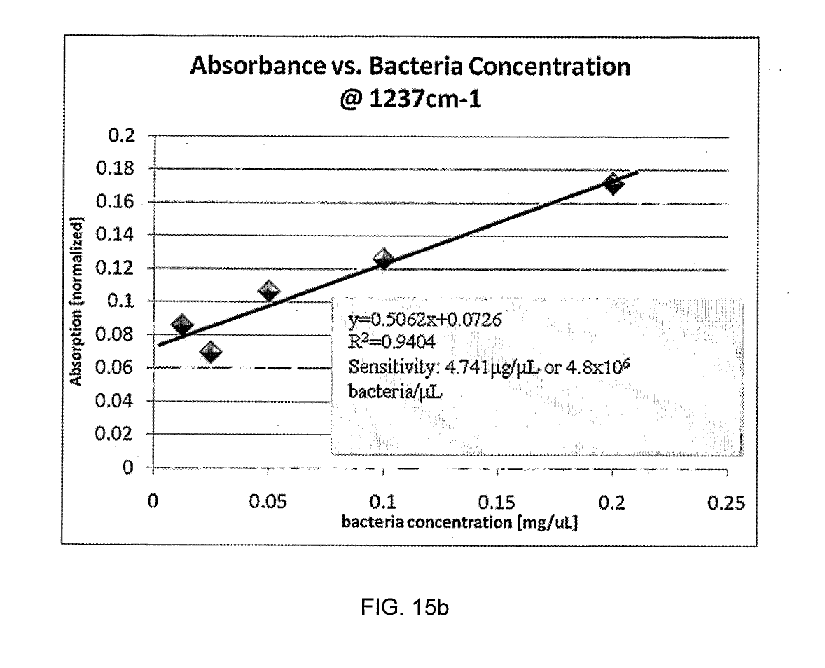

FIGS. 15a and 15b illustrate bacterial spectral signal at 1237 cm⁻¹ region for different bacteria concentrations (FIG. 15a) and the absorbance as a function of the bacteria concentration (FIG. 15b).

As can be seen from the figures the absorbance increases with the concentration. This is due to a higher number of bacteria that absorb light.

It is possible to compute the current experimental setup sensitivity to bacteria concentration (with the aid of FIG. 15a).

As described above, the sensitivity is defined as the minimal bacteria concentration that can be detected using the current experimental setup.

Mathematically (first approximation) it is the point where the linear graph intersects the x-axis. Since there is a signal bias the intersection is with 0.0075 absorbance line (about 5% above the noise level). In order to compute the current experimental setup sensitivity the linear fit (least squares) of the graph and the point where it intersects the x-axis were calculated. The measured sensitivity at 1234 cm⁻¹ is 4.741 μg/μL or 4.8×10⁶ bacteria/μL.

Sensitivity at 1084 cm⁻¹

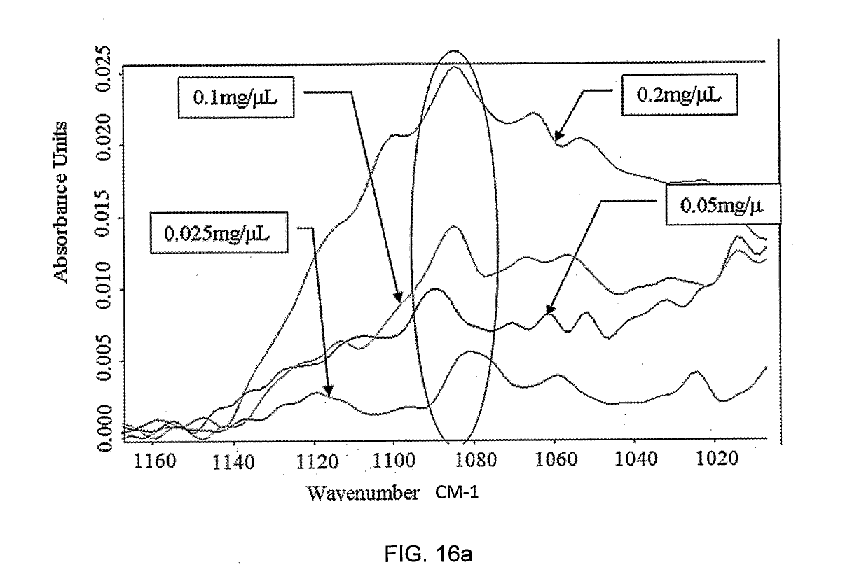

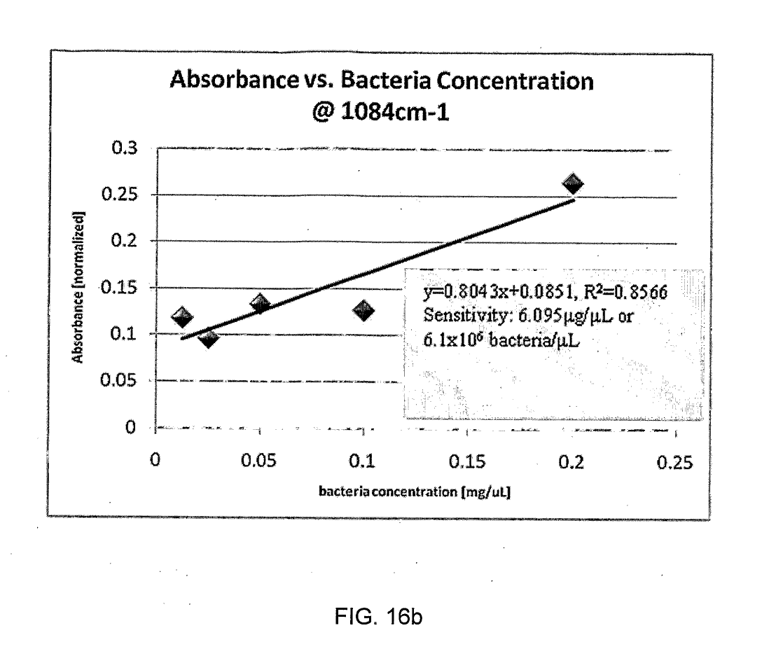

The following figures (FIGS. 16a and 16b) illustrates the bacteria spectral signal at 1084 cm⁻¹ region for different bacteria concentrations (FIG. 16a) and the absorbance as a function of the bacteria concentration (FIG. 16b).

Again, the absorbance increases with the concentration. The same analysis was applied to this wavelength region. The measured sensitivity at 1084 cm⁻¹ is 6.095 μg/μL, or 6.1×10⁶ bacteria/μL.

### Example 5

### Detection of Strep Throat in an Aerosol Sample

The term “Strep throat” or “streptococcal pharyngitis” or “Streptococcal Sore Throat” refers hereinafter to group A streptococcal infection that affects the pharynx. The system and method of the present invention were tested on 13 patients suspected to have Strep. throat.

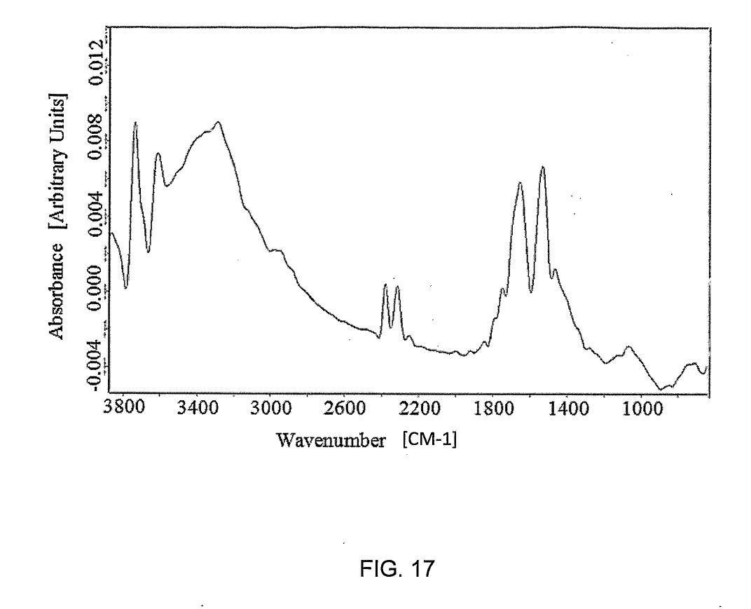

FIG. 17 illustrates the spectrum of the coughed aerosols taken from a patient suspected to have Strep.

After the above described method was implemented a graph demonstrating the boundaries between patients having Strep A and patient not having Strep. A.

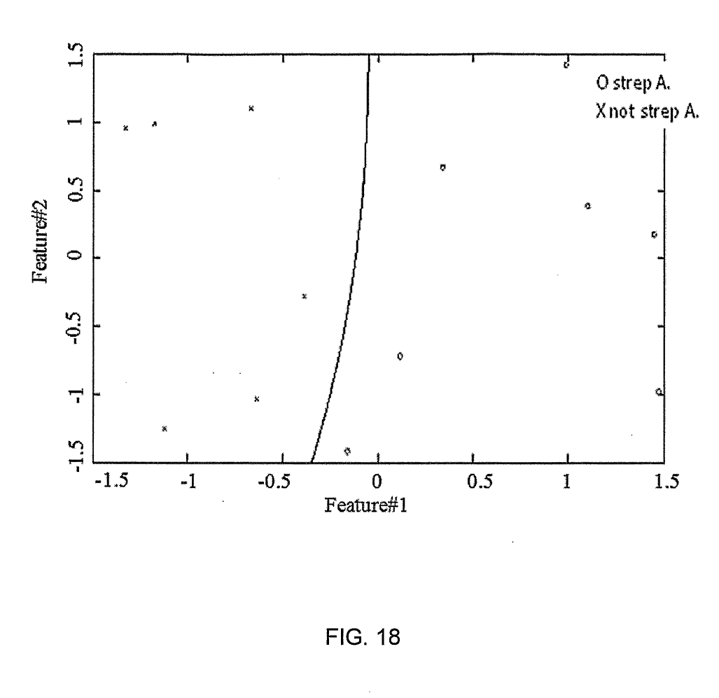

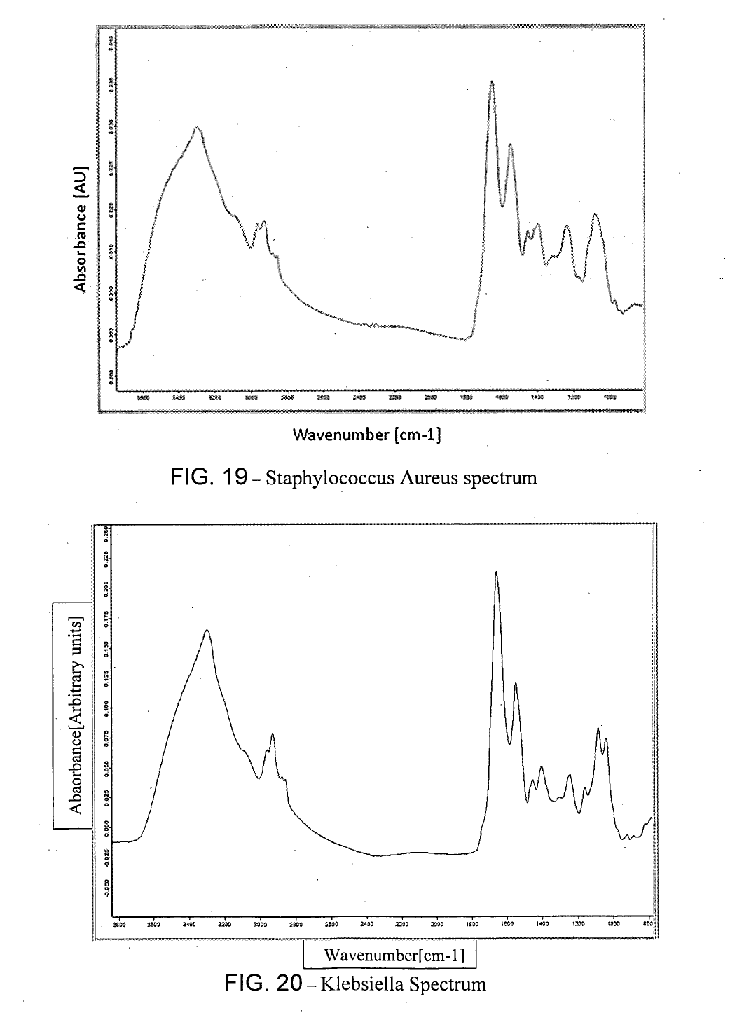

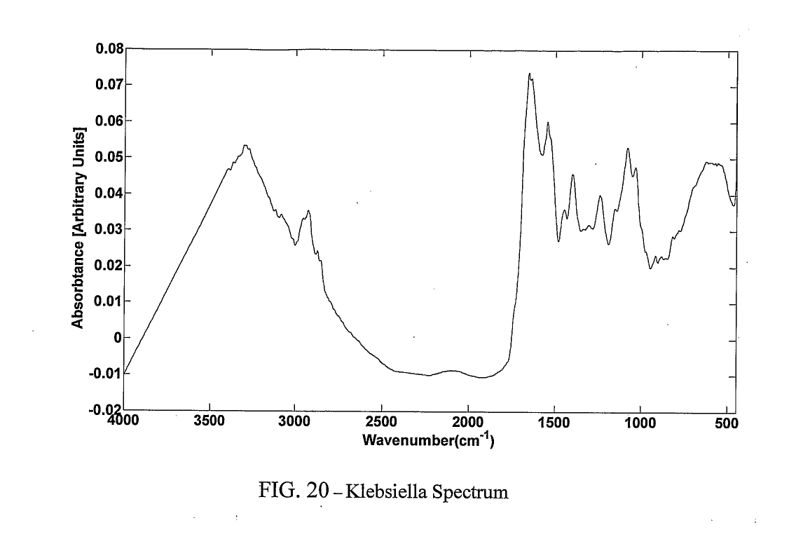

FIG. 18 illustrates the classification results and separation between patients that were Strep. A. positive and those who were Strep. A. negative.

The features that were selected were:

Feature #1 cD1(17) which is coefficient # 17 in the approximation of level # 1 with db2 wavelet transform, where db2 is the Daubechies family wavelet of order 2.

Feature #2: First derivative value at 954.0295 cm⁻¹ after water removal. As can be seen from the figure, patients having Strep. A are identified.

### Example 6

### Non Medical Applications

According to another embodiment of the present invention, the method as described above can be used to detect bacteria such as anthrax (AVA and Next Generation), smallpox, ricin, equine encephalitis, clostridium botulinum (bacteria), francisella tularemia (bacterial disease), viral hemorrhagic fevers and yersinia pestis. hazardous material: Mercury, Pharmaceuticals, Radiologicals, Sterilants and disinfectants, Cleaning chemicals, Laboratory chemicals, Pesticides Bioaccumulative Toxics

This can be used in:

(i) environmental monitoring—hazardous material and bacteria located in crowded places such as airports, trains, planes, cruise ships, stadiums etc.

(ii) Ventilation systems—checking ventilation systems for hazardous materials. According to a preferred embodiment, the ventilation system can be monitored in hospitals, cruise ships etc.

(iii) Water reservoirs, water systems etc.—Coliform and E. coli;

(iv) Food and beverage production lines—Aeromonas cavia, Aeromonas hydrophila Aeromonas sobria, Bacillus cereus, Campylobacter jejuni, Citrobacter spp, lostridium botulinum, Clostridium perfringens, Enterobacter spp., Enterococcus spp., Escherichia coli enteroinvasive strains, Escherichia Coli enteropathogenic strains, Escherichia Coli enterotoxigenic strains, Escherichia Coli O157:H7, Klebsiella spp (as illustrated in FIG. 20), Listeria monocytogenes, Plesiomonas shigelloides, Salmonella spp, Shigella spp, Staphylococcus aureus (as illustrated in FIG. 19), Streptococcus spp, Vibrio cholera, Yersinia enterocolitica

Bio defense and terror—detecting airborne bacteria, chemical agents etc.

1-38. (canceled)

39. A method for detecting and/or identifying specific bacteria within an uncultured sample; said method comprising:
a. obtaining an absorption spectrum (AS) of said uncultured sample;
b. acquiring the n dimensional volume boundaries for said specific bacteria by
i. obtaining at least one absorption spectrum (AS2) of known samples containing said specific bacteria;
ii. extracting xfeatures from said entire AS2; said xfeatures are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; x is an integer higher or equal to one; x is an integer greater than or equal to one;
iii. dividing said AS2 into several segments according to said x features;
iv. calculating y features of each of said segment of said AS2; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; y is an integer higher or equal to one;
v. assigning at least one of said x features and/or at least one of said y features to said specific bacteria by algorithms selected from a group consisting of Sequential Backward Selection, Sequential Forward Selection, Sequential Forward Floating Selection (SFFS), Max-Min algorithm, trace(S_{b})/trace(S_{w}); S_{w}/(S_{b}+S_{w}); Kullback-Lieber divergence; correct classification rate; and any combination thereof;
vi. defining n dimensional space; n equals the sum of said x and said yfeatures;
vii. defining the n dimensional volume in said n dimensional space;
viii. determining said boundaries of said n dimensional volume by using technique selected from a group consisting of Bayes classifier, Support Vector Machine (SVM), Linear discriminant, functions and Fisher's linear discriminant, Gaussian Mixed Model (GMM), C4.5 algorithm tree, K-nearest neighbor, Weighted K-nearest neighbor, Hierarchical clustering algorithm, K-mean clustering algorithm, Ward's clustering algorithm, Minimum least square, Neural-Network or any combination thereof;
c. data processing said AS;
i. noise reducing by using different smoothing techniques selected from a group consisting of running average savitzky-golay, low pass filter or any combination thereof;
ii. extracting m features from said entire AS; said m features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m is an integer higher or equal to one;
iii. dividing said AS into several segments according to said m features;
iv. calculating m₁ features of each of said segment; said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₁ is an integer greater than or equal to one; and,
d. detecting and/or identifying said specific bacteria if said m₁ features and/or said m features are within said n dimensional volume;
wherein said sample is an aerosol sample selected from a group consisting of cough, sneeze, saliva, mucus, bile, urine, vaginal secretions, middle ear aspirate, pus, pleural effusions, synovial fluid, abscesses, cavity swabs, serum, blood and spinal fluid.

40. The method for detecting and/or identifying specific bacteria within an uncultured sample according to claim 39, additionally comprising step of selecting said x feature and/or said y features via algorithms selected form Chi-Squared, χ2, test, Wilcoxon test, and t-test or any combination thereof.

41. The method for detecting and/or identifying specific bacteria within an uncultured sample according to claim 39, wherein said step of acquiring the n dimensional volume boundaries for the specific bacteria, additionally comprising step of calculating the Gaussian distribution and/or Multivariate Gaussian distribution, and/or Rayleigh distribution, and/or Maxwell distribution, and/or Estimate the distribution by the Parzen method, or mixed model, the Gaussian Mixed Model (GMM) for at least one of the n features such that the distributions defines the n dimensional volume in the n dimensional space.

42. The method for detecting and/or identifying specific bacteria within an uncultured sample according to claim 39, wherein said step (c) of data processing said AS additionally comprising steps of:
i. calculating at least one of the o^{th} derivative of said AS; said o is an integer greater than or equals 1;
ii. extracting m₂ features from said entire o^{th} derivative spectrum; said m₂ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one;
iii. dividing said o^{th} derivative into several segments according to said m₂ features;
iv. calculating the m₃ features in at least one of said segments; said m₃ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one; and,
v. detecting and/or identifying said specific bacteria if said m₁ and/or m₃ features and/or said m and/or said m₂ features are within said n dimensional volume.

43. The method for detecting and/or identifying specific bacteria within an uncultured sample according to either one of claim 39, additionally comprising the step of selecting said specific bacteria selected from a group consisting of Streptococcus Pyogenes, Group B, C and G beta-hemolytic streptococci, Corynebacterium haemolyticum pseudodiphtheriticum, Diphtheria and Ulcerans, Neisseria Gonorrhoeae, Mycoplasma Pneumoniae, Yersinia Enterocolitica, Mycobacterium tuberculosis, Chlamydia Trachomatiss and Pneumoniae, Bordetella Pertussis, Legionella spp, Pneumocystis Carinii, Nocardia, Histoplasma Capsulatum, Coccidioides Immitis, Haemophilus influenza group A beta hemolytic, Streptococcus Viridans, streptococcus Pneumonia, Staph epidermidis, Corynebacterium, Moraxella catarrhalis, Klebsiella, Escherichia Coli, staphylococcus Aureus, Streptococcus Bovis, Streptococcus Agalactiae, Streptococcus pneumonia, Staphylococcus epidermidis, Klebsiella pneumonia, E. coli or any combination thereof.

44. The method for detecting and/or identifying specific bacteria within an uncultured sample according to claim 39, wherein said step of obtaining the AS additionally comprising steps of:
a. providing at least one optical cell accommodates said uncultured sample;
b. providing p light source selected from a group consisting of laser, lamp, LEDs tunable lasers, monochrimator, p is an integer equal or greater than 1; said p light source are adapted to emit light to said optical cell;
c. providing detecting means for receiving the spectroscopic data of said sample;
d. emitting light from said light source at different wavelength to said optical cell; and,
e. collecting said light exiting from said optical cell by said detecting means; thereby obtaining said AS.

45. The method for detecting and/or identifying specific bacteria within an uncultured sample according to claim 44, wherein said step of emitting light is performed at the wavelength range of UV, visible, IR, mid-IR, far-IR and terahertz.

46. The method for detecting and/or identifying specific bacteria within an uncultured sample according to claim 39, additionally comprising the step of detecting said bacteria by analyzing said AS in the region of about 3000-3300 cm⁻¹ and/or about 850-1000 cm⁻¹ and/or about 1300-1350 cm⁻¹, and/or about 2836-2995 cm⁻¹, and/or about 1720-1780 cm⁻¹, and/or about 1550-1650 cm⁻¹, and/or about 1235-1363 cm⁻¹, and/or about 990-1190 cm⁻¹ and/or about 1500-1800 cm⁻¹ and/or about 2800-3050 cm⁻¹ and/or about 1180-1290 cm⁻¹.

47. A method for detecting and/or identifying specific bacteria within an uncultured sample; said method comprising:
a. obtaining an absorption spectrum (AS) of said uncultured sample; said AS containing water influence;
b. acquiring the n dimensional volume boundaries for said specific bacteria by:
i. obtaining at least one absorption spectrum (AS2) of known samples containing said specific bacteria;
ii. extracting x features from said AS2; said x features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; x is an integer higher or equal to one; x is an integer greater than or equal to one;
iii. calculating at least one derivative of said AS2;
iv. dividing said AS2 into several segments according to said x features;
v. calculating the y features of each of said segment; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; y is an integer higher or equal to one;
vi. assigning at least one of said x features and/or at least one of said y features to said specific bacteria by algorithms selected from a group consisting of Sequential Backward Selection, Sequential Forward Selection, Sequential Forward Floating Selection (SFFS), Max-Min algorithm, trace(S_{b})/trace(S_{w}); S_{w}/(S_{b}+S_{w}); Kullback-Lieber divergence; correct classification rate; and any combination thereof;
vii. defining n dimensional space; n equals the sum of said x features and said y features;
viii. defining the n dimensional volume in said n dimensional space;
ix. determining said boundaries of said n dimensional volume by using technique selected from a group consisting of Bayes classifier, Support Vector Machine (SVM), Linear discriminant, functions and Fisher's linear discriminant, Gaussian Mixed Model (GMM), C4.5 algorithm tree, K-nearest neighbor, Weighted K-nearest neighbor, Hierarchical clustering algorithm, K-mean clustering algorithm, Ward's clustering algorithm, Minimum least square, Neural-Network or any combination thereof;
c. eliminating said water influence from said AS by at least one of the following methods: Low pass filter, High pass filter and Water absorption division;
d. data processing said AS without said water influence by
i. noise reducing by using different smoothing techniques selected from a group consisting of running average savitzky-golay, low pass filter or any combination thereof;
ii. extracting m features from said entire AS; said m features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m is an integer greater or equal to one;
iii. dividing said AS into several segments according to said m features;
iv. calculating the m₁ features of at least one of said segment; said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₁ is an integer greater than or equal to one; and,
e. detecting and/or identifying said specific bacteria if said m₁ features and/or said m features are within said n dimensional volume;
wherein said sample is an aerosol sample selected from a group consisting of cough, sneeze, saliva, mucus, bile, urine, vaginal secretions, middle ear aspirate, pus, pleural effusions, synovial fluid, abscesses, cavity swabs, serum, blood and spinal fluid.

48. The method for detecting and/or identifying specific bacteria within an uncultured sample according to claim 47, additionally comprising step of selecting said x feature and/or said y features via algorithms selected form Chi-Squared, χ2, test, Wilcoxon test, and t-test or any combination thereof.

49. The method for detecting and/or identifying specific bacteria within an uncultured sample according to claim 47, wherein said step of acquiring the n dimensional volume boundaries for the specific bacteria, additionally comprising step of calculating the Gaussian distribution and/or Multivariate Gaussian distribution, and/or Rayleigh distribution, and/or Maxwell distribution, and/or Estimate the distribution by the Parzen method or by or mixed model, Gaussian Mixed Model (GMM) for at least one of the n features such that the distributions defines the n dimensional volume in the n dimensional space.

50. The method for detecting and/or identifying specific bacteria within an uncultured sample according to claim 47, wherein said step (c) of data processing said AS without said water influence, additionally comprising steps of
i. calculating at least one of the o^{th} derivative of said AS; said o is an integer greater than or equals 1;
ii. extracting m₂ features from said entire o^{th} derivative spectrum; said m₂ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one;
iii. dividing said o^{th} derivative into several segments according to said m₂ features;
iv. calculating the m₃ features in at least one of said segments; said m₃ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one; and,
v. detecting and/or identifying said specific bacteria if said m₁ and/or m₃ features and/or said m and/or said m₂ features are within said n dimensional volume.

51. The method for detecting and/or identifying specific bacteria within an uncultured sample according to claim 47, additionally comprising the step of selecting said specific bacteria selected from a group consisting of Streptococcus Pyogenes, Group B, C and G beta-hemolytic streptococci, Corynebacterium haemolyticum pseudodiphtheriticum, Diphtheria and Ulcerans, Neisseria Gonorrhoeae, Mycoplasma Pneumoniae, Yersinia Enterocolitica, Mycobacterium tuberculosis, Chlamydia Trachomatiss and Pneumoniae, Bordetella Pertussis, Legionella spp, Pneumocystis Carinii, Nocardia, Histoplasma Capsulatum, Coccidioides Immitis, Haemophilus influenza group A beta hemolytic, Streptococcus Viridans, streptococcus Pneumonia, Staph epidermidis, Corynebacterium, Moraxella catarrhalis, Klebsiella, Escherichia Coli, staphylococcus Aureus, Streptococcus Bovis, Streptococcus Agalactiae, Streptococcus pneumonia, Staphylococcus epidermidis, Klebsiella pneumonia, E. coli or any combination thereof.

52. The method for detecting and/or identifying specific bacteria within an uncultured sample according to claim 47, wherein said step of obtaining the AS additionally comprising steps of:
a. providing at least one optical cell accommodating said uncultured sample;
b. providing p light source selected from a group consisting of laser, lamp, LEDs tunable lasers, monochrimator, p is an integer equal or greater than 1; said p light source are adapted to emit light to said optical cell;
c. providing detecting means for receiving the spectroscopic data of said sample;
d. emitting light from said light source at different wavelength to said optical cell;
e. collecting said light exiting from said optical cell by said detecting means; thereby obtaining said AS.

53. The method for detecting and/or identifying specific bacteria within an uncultured sample according to claim 52, wherein said step of emitting light is performed at the wavelength range of UV, visible, IR, mid-IR, far IR and terahertz.

54. The method for detecting and/or identifying specific bacteria within an uncultured sample according to claim 47, wherein the absorption spectra is obtained using an instrument selected from the group consisting of a spectrometer, Fourier transform infrared spectrometer, a fluorometer and a Raman spectrometer.

55. The method for detecting and/or identifying specific bacteria within an uncultured sample according to claim 47, wherein said aerosol sample is taken from the human body.

56. A system 1000 adapted to detect and/or identify specific bacteria within an uncultured sample; said system comprising:
a. means 100 for obtaining an absorption spectrum (AS) of said uncultured sample;
b. statistical processing means 200 for acquiring the n dimensional volume boundaries for said specific bacteria; said means 200 are characterized by:
i. means 201 for obtaining at least one absorption spectrum (AS2) of known samples containing said specific bacteria;
ii. means 202 for extracting xfeatures from said entire AS2; said xfeatures are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; x is an integer higher or equal to one;
iii. means 203 for dividing said AS2 into several segments according to said x features;
iv. means 204 for calculating y features from at least one of each of said segment; said yfeatures are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; y is an integer higher or equal to one;
v. means 205 assigning at least one of said x features and/or at least one of said y features to said specific bacteria by algorithms selected from a group consisting of Sequential Backward Selection, Sequential Forward Selection, Sequential Forward Floating Selection (SFFS), Max-Min algorithm, trace(S_{b})/trace(S_{w}); S_{w}/(S_{b}+S_{w}); Kullback-Lieber divergence; correct classification rate; and any combination thereof;
vi. means 206 for defining n dimensional space; n equals the sum of said x features and said y features;
vii. means 207 for defining the n dimensional volume in the n dimensional space;
viii. means 208 for determining said boundaries of said n dimensional volume by using technique selected from a group consisting of Bayes classifier, Support Vector Machine (SVM), Linear discriminant, functions and Fisher's linear discriminant, Gaussian Mixed Model (GMM), C4.5 algorithm tree, K-nearest neighbor, Weighted K-nearest neighbor, Hierarchical clustering algorithm, K-mean clustering algorithm, Ward's clustering algorithm, Minimum least square, Neural-Network or any combination thereof;
ix. means 209 for assigning the n dimensional volume to said specific bacteria;
c. means 300 for data processing said AS; said means 300 are characterized by
i. means 301 for noise reducing by using different smoothing techniques selected from a group consisting of running average savitzky-golay, low pass filter or any combination thereof;
ii. means 302 for extracting m features from said entire AS; said m features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m is an integer higher or equal to one;
iii. means 303 for dividing said AS into several segments according to said m features;
iv. means 304 for calculating the m₁ features of at least one of said segment; said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₁ is an integer greater than or equal to one; and,
d. means 400 for detecting and/or identifying said specific bacteria if said m₁ features and/or said m features are within said n dimensional volume;
wherein said sample is an aerosol sample selected from a group consisting of cough, sneeze, saliva, mucus, bile, urine, vaginal secretions, middle ear aspirate, pus, pleural effusions, synovial fluid, abscesses, cavity swabs, serum, blood and spinal fluid.

57. The system 1000 according to claim 56, additionally comprising means for selecting said x feature and/or said y features via algorithms selected form Chi-Squared, χ2, test, Wilcoxon test, and t-test or any combination thereof.

58. The system 1000 according to claim 56, wherein said statistical processing means 200 additionally comprising means 210 for calculating the Gaussian distribution or Multivariate Gaussian distribution, or Rayleigh distribution, or Maxwell distribution, or Estimate the distribution by the Parzen method, or mixed model, the Gaussian Mixed Model (GMM) for at least one of the n features such that the distributions defines the n dimensional volume in the n dimensional space.

59. The system 1000 according to claim 56, wherein said means 300 for data processing said AS additionally characterized by:
i. means 305 for calculating at least one of the o^{th} derivative of said AS; said o is an integer greater than or equals 1;
ii. means 306 for extracting m₂ features from said entire o^{th} derivative spectrum; said m₂ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one;
iii. means 307 for dividing said o^{th} derivative into several segments according to said m₂ features;
iv. means 308 for calculating the m₃ features in at least one of said segments; said m₃ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one; and,
v. means 309 for detecting and/or identifying said specific bacteria if said m₁ and/or m₃ features and/or said m and/or said m₂ features are within said n dimensional volume.

60. The system 1000 according to claim 56, wherein said specific bacteria is selected from a group consisting of Streptococcus Pyogenes, Group B, C and G beta-hemolytic streptococci, Corynebacterium haemolyticum pseudodiphtheriticum, Diphtheria and Ulcerans, Neisseria Gonorrhoeae, Mycoplasma Pneumoniae, Yersinia Enterocolitica, Mycobacterium tuberculosis, Chlamydia Trachomatiss and Pneumoniae, Bordetella Pertussis, Legionella spp, Pneumocystis Carinii, Nocardia, Histoplasma Capsulatum, Coccidioides Immitis, Haemophilus influenza group A beta hemolytic, Streptococcus Viridans, streptococcus Pneumonia, Staph epidermidis, Corynebacterium, Moraxella catarrhalis, Klebsiella, Escherichia Coli, staphylococcus Aureus, Streptococcus Bovis, Streptococcus Agalactiae, Streptococcus pneumonia, Staphylococcus epidermidis, Klebsiella pneumonia, E. coli or any combination thereof.

61. The system 1000 according to claim 56, wherein said means 100 for obtaining an absorption spectrum (AS) of said sample additionally comprising:
a. at least one optical cell for accommodating said uncultured sample;
b. p light source selected from a group consisting of laser, lamp, LEDs tunable lasers, monochrimator, p is an integer equal or greater than 1; said p light source are adapted to emit light at different wavelength to said optical cell; and,
c. detecting means for receiving the spectroscopic data of said sample exiting from said optical cell.

62. The system 1000 according to claim 61, wherein said p light source are adapted to emit light at wavelength range selected from a group consisting of UV, visible, IR, mid-IR, far-IR and terahertz.

63. A system 2000 adapted to detect and/or identify specific bacteria within an uncultured sample; said system 2000 comprising:
a. means 100 for obtaining an absorption spectrum (AS) of said uncultured sample; said AS containing water influence;
b. statistical processing means 200 for acquiring the n dimensional volume boundaries for said specific bacteria; said means 200 are characterized by:
i. means 201 for obtaining at least one absorption spectrum (AS2) of known samples containing said specific bacteria;
ii. means 202 for extracting xfeatures from said entire AS2; said xfeatures are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; x is an integer higher or equal to one; x is an integer greater than or equal to one;
iii. means 203 for dividing said AS2 into several segments according to said x features;
iv. means 204 for calculating the y features of at least one of said segments; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; y is an integer higher or equal to one;
v. means 205 for assigning at least one of said x features and/or at least one of said y features to said specific bacteria by algorithms selected from a group consisting of Sequential Backward Selection, Sequential Forward Selection, Sequential Forward Floating Selection (SFFS), Max-Min algorithm, trace(S_{b})/trace(S_{w}); S_{w}/(S_{b}+S_{w}); Kullback-Lieber divergence; correct classification rate; and any combination thereof;
vi. means 206 for defining n dimensional space; n equals the sum of said x features and said yfeatures;
vii. means 207 for defining the n dimensional volume in said n dimensional space;
viii. means 208 for determining said boundaries of said n dimensional volume by using technique selected from a group consisting of Bayes classifier, Support Vector Machine (SVM), Linear discriminant, functions and Fisher's linear discriminant, Gaussian Mixed Model (GMM), C4.5 algorithm tree, K-nearest neighbor, Weighted K-nearest neighbor, Hierarchical clustering algorithm, K-mean clustering algorithm, Ward's clustering algorithm, Minimum least square, Neural-Network or any combination thereof;
ix. means 209 for assigning said n dimensional volume to said specific bacteria;
c. means 300 for eliminating said water influence from said AS selected from a group consisting of; Low pass filter, High pass filter and Water absorption division
d. means 400 for data processing said AS without said water influence; said means 400 are characterized by:
i. means 401 for noise reducing by using different smoothing techniques selected from a group consisting of running average savitzky-golay, low pass filter or any combination thereof;
ii. means 402 for extracting m features from said entire AS; said m features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m is an integer greater than or equal to one;
iii. means 403 for dividing said AS into several segments according to said m features;
iv. means 404 for calculating m₁ features at least one of said segments; said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (ν,σ,Ai), different peaks' intensity ratios, wavelet coefficients or any combination thereof; m₁ is an integer greater than or equal to one; and,
e. means 500 for detecting and/or identifying said specific bacteria if said m₁ features and/or said m features are within said n dimensional volume;
wherein said sample is an aerosol sample selected from a group consisting of cough, sneeze, saliva, mucus, bile, urine, vaginal secretions, middle ear aspirate, pus, pleural effusions, synovial fluid, abscesses, cavity swabs, serum, blood and spinal fluid.

64. The system 2000 according to claim 63, additionally comprising means for selecting said x feature and/or said y features via algorithms selected form Chi-Squared, χ2, test, Wilcoxon test, and t-test or any combination thereof.

65. The system 2000 according to claim 63, wherein said statistical processing means 200 additionally comprising means 210 for calculating the Gaussian distribution or Multivariate Gaussian distribution, or Rayleigh distribution, or Maxwell distribution, or Estimate the distribution by the Parzen method, or mixed model, the Gaussian Mixed Model (GMM) for at least one of the n features such that the distributions defines the n dimensional volume in the n dimensional space.

66. The system 2000 according to claim 63, wherein said means 400 for data processing said AS without said water influence additionally comprising:
i. means 405 for calculating at least one of the o^{th} derivative of said AS; said o is an integer greater than or equals 1;
ii. means 406 for extracting m₂ features from said entire o^{th} derivative spectrum; said m₂ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one;
iii. means 407 for dividing said o^{th} derivative into several segments according to said m₂ features;
iv. means 408 for calculating the m₃ features from at least one of said segments; said m₃ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one; and,
v. means 409 for detecting and/or identifying said specific bacteria if said m₁ and/or m₃ features and/or said m and/or said m₂ features are within said n dimensional volume.

67. The system 2000 according to claim 63, wherein said specific bacteria is selected from a group consisting of Streptococcus Pyogenes, Group B, C and G beta-hemolytic streptococci, Corynebacterium haemolyticum pseudodiphtheriticum, Diphtheria and Ulcerans, Neisseria Gonorrhoeae, Mycoplasma Pneumoniae, Yersinia Enterocolitica, Mycobacterium tuberculosis, Chlamydia Trachomatiss and Pneumoniae, Bordetella Pertussis, Legionella spp, Pneumocystis Carinii, Nocardia, Histoplasma Capsulatum, Coccidioides Immitis, Haemophilus influenza group A beta hemolytic, Streptococcus Viridans, streptococcus Pneumonia, Staph epidermidis, Corynebacterium, Moraxella catarrhalis, Klebsiella, Escherichia Coli, staphylococcus Aureus, Streptococcus Bovis, Streptococcus Agalactiae, Streptococcus pneumonia, Staphylococcus epidermidis, Klebsiella pneumonia, E. coli, or any combination thereof.

68. The system 2000 according to claim 63, wherein said means 100 for obtaining an absorption spectrum (AS) of said sample additionally comprising:
a. at least one optical cell for accommodating said uncultured sample;
b. p light source selected from a group consisting of laser, lamp, LEDs tunable lasers, monochrimator, p is an integer equal or greater than 1; said p light source are adapted to emit light at different wavelength to said optical cell; and,
c. detecting means for receiving the spectroscopic data of said sample exiting from said optical cell.

69. The system 2000 according to claim 68, wherein said p light source are adapted to emit light at wavelength range selected from a group consisting of UV, visible, IR, mid-IR, far-IR and terahertz.

70. The system according to claim 56, wherein the absorption spectra is obtained using an instrument selected from the group consisting of a spectrometer, Fourier transform infrared spectrometer, a fluorometer and a Raman spectrometer.

71. The system according to claim 56, wherein said aerosol sample is taken from the human body.

72. The system according to claim 56, additionally comprising means adapted to recommend, after the specific bacteria has been identified, what kind of antibiotics and medicine to take.

73. The method according to claim 39, additionally comprising step of recommending, after the specific bacteria has been identified, what kind of antibiotics and medicine to take.

74. The system according to claim 56, wherein said sample is an aerosol sample obtained from air moisture and/or contaminations in air condition systems.

75. The method according to claim 39, wherein said sample is an aerosol sample obtained from air moisture and/or contaminations in air condition systems.

76. The system according to claim 56, wherein the sensitivity of said system is less than 6×10⁶ bacteria/μL.
